(19) United States
(12) Patent Application Publication
(10) Pub. No.: US 2016/0258263 A1
(43) Pub. Date: Sep. 8, 2016

(54) Solar Calciner Enhanced Oil Recovery

(71) Applicant: David LeRoy Hagen, Goshen, IN (US)

(72) Inventor: David LeRoy Hagen, Goshen, IN (US)

(73) Assignee: VAST POWER SYSTEMS, INC., Chicago, IL (US)

(21) Appl. No.: 14/641,275

(22) Filed: Mar. 6, 2015

(51) Int. Cl. E21B 43/16; C09K 8/594; E21B 43/34

(52) U.S. Cl. CPC E21B 43/164; E21B 43/34; C09K 8/594

(57) ABSTRACT

A method of supplying crushed alkaline carbonate from a carbonate resource to a first calcining site having a design calcining capacity; solar calcining crushed carbonate within a prescribed carbon dioxide (CO2) delivery distance from a first enhancement location within a first hydrocarbon resource, whereby generating CO2 with a local CO2 generating capacity and an alkaline oxide; forming a first enhancing fluid comprising generated CO2 and delivering it into the first enhancement site having an injector well weighted first enhancement location, whereby mobilizing hydrocarbon in the first enhancement site; producing a produced fluid comprising mobilized hydrocarbon and enhancing fluid; recovering liquid hydrocarbon from the produced fluid; wherein the prescribed CO2 delivery distance is less than 67% of a remote CO2 delivery distance, to the first enhancement location from a remote calcining site having an equal or greater design calcined CO2 generating capacity. Then solar calcining CO2 to enhance a second site.

### CROSS-REFERENCE TO RELATED APPLICATIONS

This application claims priority to U.S. nonprovisional patent application Ser. No. 14/480,271 of Sep. 8, 2014 entitled CALCINER ENHANCED OIL RECOVERY.

### BACKGROUND OF THE INVENTION

1. Field of the Invention

Hydrocarbon recovery with enhancing fluid comprising carbon dioxide generated from calcining a carbonate or bicarbonate.

2. Description of Related Art

The US 48 State domestic oil production peaked in 1970. Increasing fuel consumption with declining oil production has required growing oil imports until recently. The USA imported $10.3 trillion of oil from 1940 through 2011 (in 2011 US dollars), causing a reduction to its International Investment Position. The Energy Information Agency (herein “EIA”) of the US Department of Energy (herein “DOE”) projects the current increase in US oil production to peak about 2019 (EIA 2013). Water floods, gas floods of air, nitrogen, carbon dioxide (herein “CO2”), lighter hydrocarbons (such as methane and propane), water alternating gas (herein “WAG”), steam, surfactants, and/or foam have variously been used to enhance oil recovery or production (herein “EOR”), depending on resource depth, type and production. (Citations are detailed in References and Bibliography below.)

CO2-EOR: Using carbon dioxide to enhance oil recovery or production (herein “CO2-EOR”) has been commercially proven for over four decades since 1972. Wallace et al. (2014) report 58 million metric tons/year (3.0 Bcfd) of CO2 use in 113 projects in the USA in 2012. Kuuskraa & Wallace (2014) report 136 US enhanced oil recovery projects (CO2-EOR) that were producing 300,000 bbl/day of oil. i.e. 4.0% of US 2013 domestic production of 7.4 million bbl/day. They project US CO2-EOR production to double by 2020 to 638,000 bbl/day. That would reduce the USA's 5.3 million bbl/day of oil imports by about 12%. Kuuskraa et al. (2011) screened 7,000 US oil fields to find about 2,000 oil fields that are economically suitable for CO2-EOR.

Kuuskraa et al. (2013) report that “Next Generation” CO2-EOR could provide at least 100 billion bbl (13 billion metric ton) in economically recoverable US oil resources including CO2-EOR recovery from residual oil zones (herein “ROZ”) with at $85/bbl oil, $40/metric ton CO2 (about $2/Mscf) and a 20% Internal Rate of Return (herein “IRR”) before tax. Such economic Next Generation CO2-EOR oil would nominally need 33 billion metric ton of CO2 of which 30 billion needs to come from industrial/power sources. Wallace (2014) reports about 135 billion barrels (19 billion metric tons) of economically and technically recoverable conventional US oil using “Next Generation” Enhanced Oil Recovery, including ROZ, Alaska and offshore Gulf of Mexico. Such CO2-EOR could use 45 billion metric ton (t or “tonne”) of CO2. Kuuskraa et al. (2013) project 1,297 billion bbl technical global CO2-EOR oil recovery potential.

CO2 Shortage: However only about 2.3 billion metric ton of CO2 are conventionally available for this Next Generation EOR from existing natural and anthropogenic sources (7% of that needed for the US identified economic EOR oil potential). While CO2-EOR provides about 4.5% of US production, ARI (2010) identified: “The single largest barrier to expanding CO2 flooding today is the lack of substantial volumes of reliable and affordable CO2.” Kuuskraa et al. (2011) affirmed that: “ . . . the number one barrier to reaching higher levels of CO2-EOR production is lack of access to adequate supplies of affordable CO2.” Melzer (2012) observed: “Depletion of the source fields and/or size limitations of the pipelines are now constricting EOR growth . . . . The CO2 cost gap between industrial CO2 and the pure, natural CO2 remains a barrier.” Trentham (2012) observed “Accelerated ROZ deployment has clearly created unprecedented supply problems; many other unlisted projects await CO2 availability to begin implementation.” Godec (2014) states: “The main barrier to . . . CO2 EOR is insufficient supplies of affordable CO2” and that new industrial sources need to be developed to supply 17 of 19 billion metric tons of CO2 required to recover 66 billion bbl of conventional economically recoverable US CO2-EOR oil.

The Energy Information Agency (2014) projects that because of CO2 shortages, CO2-EOR will only increase to about 0.74 million barrels per day by 2040, enabling 5.2 billion bbl CO2-EOR oil for 2013-2040. Compare, about 1.5 billion bbl CO2-EOR oil produced from 1972 to 2012. The remaining 94% of identified economic CO2-EOR resources require developing major new industrial CO2 sources.

Cement CO2: With about 5% of global CO2 generation, the cement industry is nominally a potential source of industrial CO2. Yue (2013) modeled solar calcining of crushed limestone. Reich et al. (2014) review solar calcium looping. Gonzalez & Flamant (2014) model impacts of using solar energy in cement plants. In EPA (2010), the Environmental Protection Agency reviewed alternatives for reducing cement industry emissions. However, reviews of CO2 supplies for CO2-EOR do not mention current or planned CO2 sources from lime or cement production. The EIA expects that any development of CO2 from cement plants would take seventeen years from development to significant market penetration (seven years development followed by ten years for market acceptance). The EIA projects only 4% of Estimated Ultimate Recovery (EUR) of such CO2-EOR with CO2 from cement might be achieved.

Economic constraints: In mature calcining markets, such as for commodity lime and cement, economic downturns drop product demand causing strong declines in profitability often forcing operators to idle calciners. US cement production dropped 33% from 2007 to 2009 and a drop in price from $104 to $90 by 2011, causing plant closures and idled kilns. The EIA (2012) projected that capturing CO2 from cement plants, compressing it, and delivering it to an CO2-EOR project site via pipeline would cost more than twice that of conventional CO2 delivery from Natural Gas Processing ($4.29/Mscf vs $1.92/Mscf). Capturing CO2 from pulverized coal plants was projected to cost even more, while increasing electricity costs more than 30%.

Location & pipelines: Cement and lime kilns are almost always located close to or near to population centers or major industrial users. However, most oil fields are in geological basins distant from such population centers or industrial manufacturers. Conventional petroleum practice uses pipeline CO2 delivery as the lowest cost means to transport CO2 from natural or anthropogenic sources to CO2-EOR oilfields. Conversely, the limestone or lime transport distance is minimized, as lime and limestone are more costly to transport than delivering CO2 by gas pipeline. While the US has some 805,000 km (500,000 miles) of natural gas pipelines, More than one billion dollars worth of natural gas was flared from the Bakken oil field in North Dakota in 2012—for lack of natural gas pipelines. Furthermore, the USA only has about 5,800 km (3,600 miles) of CO2 pipelines.

Industry analysts predict that expanding CO2-EOR would require building a major new CO2 pipeline infrastructure from anthropogenic sources to CO2-EOR oil fields including mature oil fields, “brownfield” residual oil zones (herein “brownfield ROZ”) below the Main Pay Zone (“MPZ”) in conventional oil fields, and “greenfield” residual oil zones (herein “greenfield ROZ”) separate from conventional oil fields not having mobile oil readily accessible by conventional primary oil production. Not In My Backyard (NIMBY) and environmental litigation delay pipelines. The typical time for permitting and constructing CO2 pipelines would seriously delay CO2-EOR projects. Waiting for CO2 pipelines would cause lost development opportunities causing greater wealth loss from fuel imports.

Calciners and surface miners: Industry practice is to permanently install cement and lime calciners near large population centers or industrial markets with multi-decadal operating lives. Today's large rotary surface miners far exceed the production capacity of calciners. For example, a large surface miner with a capacity of 400 to 3,600 metric ton/hour, might only take 10 to 90 minutes to produce a day's worth of limestone for a 600 metric ton/day lime kiln. Surface miners are typically operated on mining projects or on very large limestone resources near railways or rivers to transport crushed rock to major markets sufficient to support their rapid production.

Public carriers: In Texas, public carriers seeking to pipeline carbon dioxide must now find and document third party customers before they can apply for eminent domain access. Conversely, parties seeking public carrier carbon dioxide for CO2-EOR usually must financially commit to a pipeline with a long wait for uncertain delivery dates. The DOE (2012) only expects fields having more than 20 million barrels of original oil in place (OOIP) to be practical for CO2-EOR. These chicken-egg barriers strongly reduce the Return On Investment (ROI) for CO2-EOR projects from cement plants and constrain the potential oil production by CO2-EOR.

Environmental barriers: Regulators are imposing increasingly stringent emissions limits. The Environmental Protection Agency's proposed rule for cement kiln emissions (EPA 2013) will require further expensive plant modifications. With overcapacity and low prices, the calcining industry is not expected to build new capacity to capture CO2. Reviews of CO2 capture technology note high costs, risks, and large energy requirements. Such poor economics and contrary markets raise major barriers against delivering CO2 for CO2-EOR from conventional calciners. In 2012, none of the DOE's CO2-EOR planned demonstration projects included carbon capture from lime kilns or cement plants.

Global Warming regulations: Lobbyists emphasizing projected dangers of catastrophic anthropogenic global warming are pressuring politicians and environmental agencies towards global warming mitigation, carbon sequestration, and major reductions in carbon dioxide generation. For example, the Environmental Protection Agency is promulgating greenhouse gas emission regulations for current and future electric power plants (EPA 2012B, 2014) that strictly limit CO2 emissions of current and future coal-fired electricity power plants likely necessitating CO2 sequestration. Conventional calcining typically generates two orders of magnitude higher NOx production per unit of energy use than gas turbine power generation. The EPA's proposed stringent new rules on coal emissions and likely future NOx and calcining restrictions will likely substantially increase calcining plant capital and operating costs and delay issuance of plant permits. Calcining by oxicombustion is being studied.

Industry structure: Carbon dioxide is commonly assumed to be obtained as a commodity product at the lowest bid commanding only about 10% of the enhanced oil recovery margin. This provides little incentive to develop CO2 supplies. While hydrocarbon resources are drilled to prove hydrocarbon reserves, the quantity of limestone resources are commonly ignored.

Other Regulations: The Society of Petroleum Engineers et al. (SPE et al. 2011) provide guidelines for evaluating CO2-EOR reserves. However, the US Securities and Exchange regulations (SEC 2009) on declaring unconventional reserves normally permit declaring only those reserves that will be developed within five years at previously demonstrated development rates. The SEC further requires proof of enhanced reservoir response in the same reservoir or an analogous reservoir. However, it has commonly taken from two to ten years to prove reservoir response from the start of injecting CO2 for enhancing oil recovery (with an occasional demonstration in one year). The USA built the trans-continental railroad in six years (1683-1689), starting during a civil war. However, the US DOE now reports that the time from resource discovery to permit issuance alone takes seven to ten years. Such delays in permitting cause a “Catch 22” confounding regulatory problem: Common permitting and construction times to establish full scale CO2-EOR delivery projects needed to count reserves are longer than the SEC prescribed five years from the evidence of CO2 response required to demonstrate those reserves.

### REFERENCES AND BIBLIOGRAPHY

ARI (2010) U.S. Oil Production Potential from Accelerated Deployment of Carbon Capture and Storage, White Paper, Advanced Resources International, Inc., Arlington, Va. USA Mar. 10, 2010.
DiPietro, P., et al. (2012) A Note on Sources of CO2 Supply for Enhanced-Oil-Recovery Operations, SPE Economics & Management, April 2012, 69-74.
DiPietro, P. (2013) Carbon Dioxide Enhanced Oil Recovery in the United States, National Energy Technology Laboratory, US Dept. of Energy, presentation Jun. 11, 2013.
DOE (2012) United States Carbon Storage Utilization and Storage Atlas (IV), November 2012 US Dept. of Energy, NatCarb Viewer http://www.NatCarbViewer.com
EIA (2012) Assumptions to the Annual Energy Outlook 2011, Energy Information Agency, US Dept. of Energy.
EIA (2013) Market Trends Oil/Liquids, Annual Energy Outlook, Energy Information Agency, April, 2013, National Energy Technology Laboratory, US Dept. of Energy DOE/EIA-0383(2013)
EIA (2014) Annual Energy Outlook 2014 with projections to 2040. DOE/EIA-0383.
EPA (2010) Available and Emerging Technologies for Reducing Greenhouse Gas Emissions from the Portland Cement Industry, Office of Air and Radiation, US Environmental Protection Agency.
EPA (2012) Regulatory Impact Analysis for the Proposed Standards of Performance for Greenhouse Gas Emissions for New Stationary Sources: Electric Utility Generating Units. EPA-452/R-12-001.
EPA (2013) National Emission Standards for Hazardous Air Pollutants for the Portland Cement Manufacturing Industry and Standards of Performance for Portland Cement Plants: Final rule 78 FR No. 29, Feb. 12, 2013, 10006-10054.
EPA (2014) Carbon Pollution Emission Guidelines for Existing Stationary Sources: Electric Utility Generating Units—Proposed Rule 79 FR No. 117 Jun. 18, 2014, 34829-34958.
Folger, P. (2013) Carbon Capture: A Technology Assessment, Congressional Research Service
Godec, M. (2014) Carbon Dioxide Enhanced Oil Recovery: Industrial CO2 Supply Crucial For EOR, American Oil & Gas Reporter, February 2014 www.aogr.com
Gonzalez, R. S. & Flamant, G. (2014) Technical and Economic Feasibility Analysis of Using Concentrated Solar Thermal Technology in the Cement Production Process: Hybrid Approach—A Case Study, J. Solar Engineering, May 2014 V. 136, 025001:1-12
Hoenig, V; Hoppe H.; & Emberger, B. (2007) Carbon Capture Technology—Options and Potentials for the Cement Industry. PCA R&D Serial No. 3022, European Cement Research Academy
EPA (2013) National Emission Standards for Hazardous Air Pollutants for the Portland Cement Manufacturing Industry and Standards of Performance for Portland Cement Plants: Final rule 78 FR No. 29, Feb. 12, 2013, 10006-10054.
Inventys—CO2 capture for $15 per tonne, Carbon Capture J. January/February 2011 #19 pp 5-6
Kuuskraa, V. A., et. al. (2011) Improving Domestic Energy Security and Lowering CO2 Emissions with “Next Generation” CO2-Enhanced Oil Recovery (CO2-EOR), Jun. 20, 2011 DOE/NETL-2011/1504
Kuuskraa, V. A., Godec, M. L. & DiPietro, P. (2013) CO2 Utilization from “Next Generation” CO2 Enhanced Oil Recovery Technology, Energy Procedia 37(2013) 6854-6866.
Kuuskraa, V. A., Wallace, M. (2014) CO2-EOR set for growth as new CO2 supplies emerge Oil & Gas Journal, 04/07/2014
McCoy, Sean T. (2009) The Economics of CO2 Transport by Pipeline and Storage in Saline Aquifers and Oil Reservoirs, Dept. Engineering and Public Policy, Paper 1, Carnegie Mellon University
Melzer, L. S. (2012) Factors Involved in Adding Carbon Capture, Utilization and Storage (CCUS) to Enhanced Oil Recovery, CO2 Flooding Conference February 2012, National Enhanced Oil Recovery Initiative.
Reich, L. et al. (2014) Towards solar thermochemical carbon dioxide capture via calcium looping: A review, Aerosol and Air Quality Research, V. 14, #2, March pp 500-514.
RITA (2012) Average Freight Revenue per Ton-mile (current ¢), National Transportation Statistics, Research and Innovation Technology Administration, Table 3-21, Bureau Transport Statistics, April.
Salmon, R., & Logan, A. (2013) Flaring Up: North Dakota Natural Gas Flaring More than Doubles in Two Years. CERES, July 2013.
SEC (2009) Securities and Exchange Commission, Federal Register/Vol. 74, No. 9/Wednesday, Jan. 14, 2009/Rules and Regulations page 2192; Undeveloped Oil and Gas Reserves [4-10(a)(31)]; Guidance (Question 131.03 in 26 Oct. 2009 CD&I)
SPE et al. (2011) Guidelines for Application of the Petroleum Resources Management System, Society Petroleum Engineers
Stell, M. (2011) An Auditor's View of Booking Reserves in CO2 EOR Projects and the ROZ, Permian Basin Study Group Residual Oil Zone Symposium, April 4, Ryder Scott Co.
Trentham, R. (2012) Developing a Case History in the Permian Basin of New Mexico and West Texas (08123-19) June 23 for Research Partnership to Secure Energy for America.
Yue, L. (2013) A numerical model of transient thermal transport phenomena in a high—temperature solid—gas reacting system for CO2 capture applications, MSc. Thesis, Univ. Minnesota
Wallace, M.; Kuuskraa, V.; & DiPietro, P. (2014) Near-Term Projections of CO2 Utilization for Enhanced Oil Recovery, April 7, US Department of Energy, DOE/NETL-2014/1648.
Zeman, F. & Lackner, K. (2008) The Reduced Emission Oxygen Kiln, July 31, The Earth Institute, Columbia University, New York, Report 2008.01

### SUMMARY OF THE INVENTION

Calcine to generate CO2 near a hydrocarbon resource: A Calciner Enhanced Oil Recovery method comprises forming a enhancing fluid comprising CO2, to enhance hydrocarbon recovery, by calcining an alkaline carbonate or bicarbonate in a calciner or kiln on or close to a carbonate or bicarbonate resource and near or above a hydrocarbon resource or reservoir. The calciner then delivers the enhancing fluid to enhance hydrocarbon recovery or “enhance oil recovery” (herein “Calciner-EOR” or “CEOR”). Similarly a solar calciner enhanced oil recovery method may concentrate sunlight into a solar calciner, such as using a heliostat or concentrator array with a beam down mirror to calcine alkaline carbonate or bicarbonate, to form and deliver the enhancing fluid comprising CO2 and alkaline carbonate near or above the hydrocarbon resource to solar enhance oil recovery (herein “Solar Calciner-EOR” or SCEOR).

Such a Calciner-EOR or Solar Calciner-EOR system inverts industry practice of calcining a carbonate to form an alkaline-earth oxide and/or an alkali oxide (herein collectively “alkaline oxide”) close to a major market such as a large city or a major industrial user. e.g., the alkaline oxide may comprise a calcium oxide (CaO, calcined limestone, “quicklime” or “lime”), a magnesium oxide (“magnesite”), a mixture thereof such as “dololime” (CaMgO₂, “calcined dolamite”), lithium oxide, sodium oxide, and/or potassium oxide, or a composite thereof, such as “cement”, “Portland cement” or “Alkali Activated Cement”, and/or mixtures thereof.

The method may form and deliver a first enhancing fluid comprising CO2 into the hydrocarbon resource at a first trial site to produce a first enhanced hydrocarbon production. For example, the method may use a first calciner or kiln, or a solar first calciner sufficient to prove a first reserve or “Contingent Resource” of CO2 enhanced hydrocarbon recovery at a first enhancement site. For example, a relatively small scale calciner such as a lime kiln. The method may similarly form and deliver a second enhancing fluid for a second enhancing hydrocarbon production at a second enhancement site. The second calciner or second solar calciner may be at a larger scale such as for production scale hydrocarbon enhancement at a first production site.

Such methods may be used to enhance a mobilizable hydrocarbon comprising one of light oil (“conventional oil”), gas oil, “tight” oil (“shale” oil) and heavy oil in mature or new fields. Such method may further be used in Residual Oil Zones (herein “ROZ”) below mature oil fields (“brownfield” ROZ) and/or in new hydrocarbon resources adjacent to or isolated from the mature oil fields, which are not recoverable by conventional primary production (“greenfield” ROZ). In some configurations, the methods may be used to mobilize hydrocarbon comprising one of extra heavy oil, bitumen (“oil sands”), or kerogen (“oil shale”).

Such methods may similarly be used to enhance recovery of a gaseous hydrocarbon such as one of coal bed methane, natural gas, “sour” gas (comprising hydrogen sulfide), or “tight gas” (shale gas). The Calciner-EOR or Solar Calciner-EOR system may beneficially provide faster and/or higher project revenue from sale of produced hydrocarbon and alkaline oxide from calcining carbonate, than from relevant art sale of alkaline oxide just from calcining carbonate, such as lime or cement.

This invention seeks to bypass the current CO2 delivery constraint of only 5,800 km (3,600 miles) of US CO2 pipeline. It helps reduce or avoid the delays, lost development opportunities, and higher fuel imports entailed in permitting and installing long CO2 pipelines, related CO2 delivery costs, and/or of the conventional systems to capture anthroprogenic CO2.

Calcine near transport: One or more calciners and/or solar calciners may be located near one or more existing road, rail, or waterways to facilitate transporting the alkaline oxide produced (e.g., lime, dololime, and/or cement) to a major market at a first alkaline oxide design transport rate. This enables transporting the alkaline oxide produced to one or more alkaline oxide demand population regions such as a large city, and/or industrial user sites such as chemical plants using alkaline oxide and/or coal fired power plants.

One or more mining and crushing systems may similarly be located near or close to major road, rail, or water transport. Crushed carbonate may then be transported to the one or more calciners or solar calciners and be calcined within a prescribed transport distance of a means of transport selected from one of the options of the road, rail, and/or water transport, where the transport means is capable of transporting crushed carbonate at a first carbonate design transport rate. Further revenue may be obtained by transporting crushed carbonate to one or more markets of population regions or industrial user sites.

Such Calciner-EOR or Solar Calciner-EOR systems may beneficially leverage a portion of one or more of the USA's existing 40,000 km (25,000 miles) of commercially navigable waterways, 275,000 km (171,000 miles) of railroad, and/or 6.3 million km (3.9 million miles) of public roads. Though it may entail longer transport of alkaline oxide to market than relevant art calcining, this invention may benefit from higher revenues for such Calciner-EOR or Solar Calciner-EOR systems. With additional revenue from enhanced oil production, the project may achieve higher annual return on investment (ROI) than large calcined oxide commodity industries marketing only lime or cement.

Initial (trial) then production calciners: This Calciner-EOR or Solar Calciner-EOR method may use a first calciner or solar first calciner to deliver the first enhancing fluid to a first pilot or trial site to initiate or prove enhanced hydrocarbon production from a hydrocarbon resource. In some configurations, the first calciner may emit less than 25,000 tonnes CO2/year into the atmosphere, while delivering between 25,000 and 250,000 tonnes CO2/year as enhancing fluid for CO2-EOR.

Then a second calciner or solar second calcine may be used to deliver the second enhancing fluid to a first production site to further enhance hydrocarbon production. In some configurations, the second calciner or solar second calciner may be a larger production calciner having greater calcining capacity than the pilot calciner. For example, the production calciner may have from 250% to 1000% the calcining capacity of the pilot scale first calciner. In other configurations, the second or production calciner or solar second calciner may comprise a plurality of calciners. e.g., this may use modular production calciners having a calcining capacity between 50% and 249% of the first calciner capacity.

One or more pilot and/or production calciners or solar calciners may then be used to deliver enhancing fluid to a second pilot or test hydrocarbon site in a second hydrocarbon resource to further begin, show enhanced hydrocarbon production and to project a second hydrocarbon reserve. Pressurized CO2 tank trucks and/or a CO2 pipeline may be provided to deliver enhancing fluid to the second test hydrocarbon site. This may provide rapid evidence of hydrocarbon enhancement before primary production has dropped to 75% or 50% of a primary production peak in the second test hydrocarbon site. Such enhancement may be demonstrated within 15, 18 or 24 months of beginning delivery to the second test hydrocarbon site.

For initial resource testing, pressurized or liquified CO2 tank trucks may be used to deliver CO2 to one or more hydrocarbon pilot or trial sites for early demonstration of enhanced hydrocarbon production. Delivering enhancing fluid before an inflection point in the rising primary production may rapid evidence of enhanced hydrocarbon production. For example, within 6, 9 or 12 months from commencing delivery of enhancing fluid comprising CO2.

In some configurations, one or more of the pilot and/or production calciners may be relocated to facilitate such enhancing fluid delivery to one of the pilot and/or production sites on one of the first and second hydrocarbon resources. After proving enhanced hydrocarbon projection, a CO2 pipeline may be accessed or provided to deliver further enhancing fluid from one or more of the trial calciners, and production calciners, existing calciners and/or new relevant art calciner to the proven hydrocarbon field.

An alkaline carbonate may be mined, crushed, screened, and delivered to the pilot or production calciner or solar calciner at a calcining site for generating CO2 for delivery into a first enhancement site at a sufficient rate and duration to prove a first hydrocarbon reserve in a first CO2 enhanceable hydrocarbon reserve. One or both of crushing and screening may be done at the mining site and/or the calcining site. For example, such enhancing hydrocarbon may be done at enhancement sites within a local calcining distance that is less than 50% of a remote calcining distance to a remote calciner having an equal or greater design calcining capacity than a design calcining capacity of the respective trial calciner, production calciner or combined local calciners.

Indirect heating such as through a high temperature heat exchanger or regenerative heat exchanger may be used to calcine an alkaline carbonate and separate the CO2 generated. The generated CO2 may be used for enhancing one or more of primary, secondary, tertiary and Quaternary hydrocarbon recovery. Herein quaternary hydrocarbon recovery comprises one or more of “brownfield residual oil recovery” and “greenfield residual oil recovery” (greenfield ROZ). Using these enhancing methods in primary production, including early primary production before peaking of primary production, is expected to strongly enhance system profitability.

### BRIEF DESCRIPTION OF THE DRAWINGS

These and other features and advantages of the present invention will become apparent from the following description of the invention which refers to the accompanying drawings, wherein like reference numerals refer to like structures across the several views, and wherein:

FIG. 1 schematically illustrates transporting, mining, calcining, solar calcining, hydrocarbon enhancing operations relative to carbonate and hydrocarbon resources and population or industrial markets;

FIG. 2 schematically illustrates trial and production scale injection and production well field layouts for water and enhancing fluid comprising CO2 in a hydrocarbon resource;

FIG. 3 schematically illustrates trial and production scale injection, blocking, and production well field layouts, for water, enhancing, blocking, and production fluids in two hydrocarbon resources;

FIG. 4 schematically illustrates separating of produced fluid into recovered hydrocarbon, enhancing fluid, and aqueous fluid;

FIG. 5 schematically illustrates increasing production of hydrocarbon mobilized by delivering enhanced recovery fluid for tertiary and quaternary production;

FIG. 6A schematically illustrates increasing production of hydrocarbon mobilized by delivery of enhancing fluid during primary production; and

FIG. 6B schematically illustrates detail of increasing production of hydrocarbon mobilized by delivery of enhancing fluid during early primary production.

FIG. 7 schematically illustrates solar calcining using a heliostat field with a beam down reflector concentrating sunlight into a solar calciner.

### DETAILED DESCRIPTION OF EMBODIMENTS OF THE INVENTION

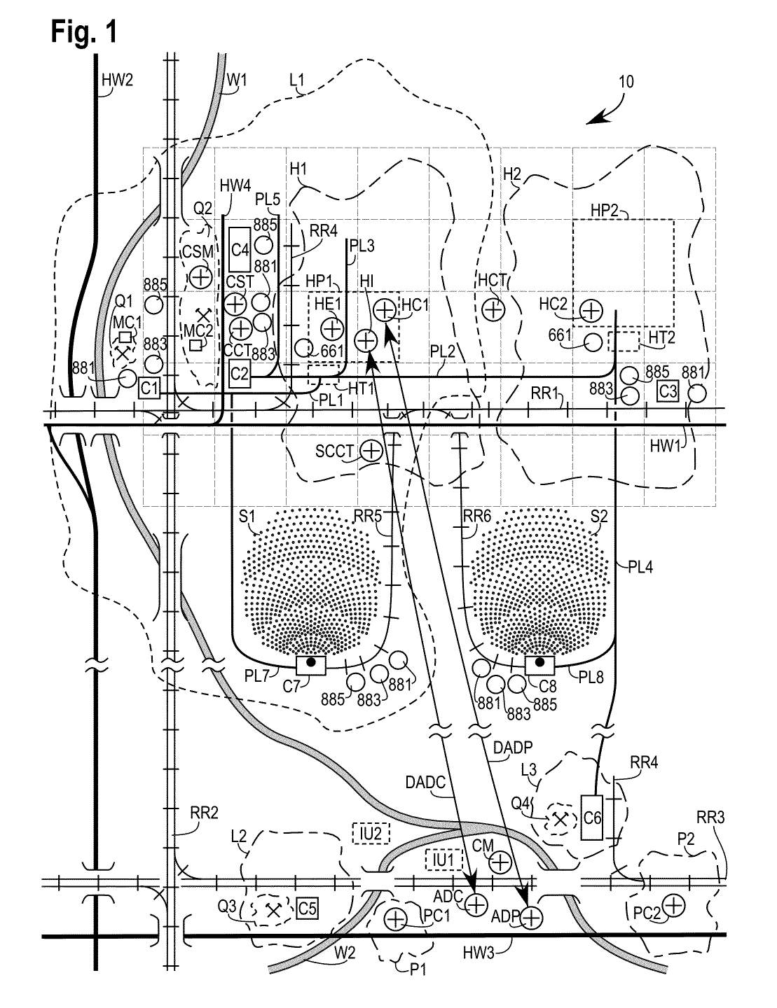

Referring to schematic FIG. 1, in some embodiments of the Calciner Enhanced Oil Recovery™ system 10, an alkaline carbonate from a first carbonate resource L1 may be mined and comminuted or crushed in a first mining-crushing system MC1 and crushed carbonate delivered to a first calciner or kiln C1 located near, close to, or on the first carbonate resource L1, and near to, close to, or over a first hydrocarbon trial site HT1 on a first fossil or hydrocarbon resource H1. Crushed carbonate comprising calcium (calcite or limestone), magnesium (magnesite), or a mixture thereof (e.g. dolomite), may be heated or calcined in the first calciner C1 sufficiently to generate CO2 and an alkaline oxide comprising calcium oxide (lime), magnesium oxide (magnesia), or a mixture thereof (dololime).

Some embodiments provide for delivering the first enhancing fluid comprising a first portion of the generated CO2 using a first local enhancing pipeline PL1 and injecting the first enhancing fluid into the first hydrocarbon trial site HT1 in the first fossil resource H1 to enhance hydrocarbon recovery. A second portion of the generated CO2 may be delivered by a second pipeline PL2 and be injected into a second hydrocarbon pilot or trial site HT2 in a second hydrocarbon resource H2 for “carbon dioxide enhanced oil recovery” (herein “CO2-EOR”).

Mining-crushing: Referring further to FIG. 1, in some configurations the first mining-crushing system MC1 may be used to mine and crush alkaline carbonate from a first quarry Q1 in the carbonate resource L1 near or over the hydrocarbon resource H1. The mining-crushing system may comprise one or more of surface mining, drilling, blasting, excavating, and crushing limestone in the first quarry Q1. This may be in an existing quarry or include opening a new quarry. Some configurations may use a second mining-crushing system MC2 to develop a second quarry Q2 in the carbonate resource L1. e.g., this second quarry Q2 may be a new quarry similar to or larger than the first quarry Q1. It may be further configured for surface mining.

In some embodiments, the mining-crushing systems MC1 and/or MC2 may comprise one or more surface miners. For example, in some configurations the surface miner in one or both mining-crushing systems MC1 and/or MC2 may comprise the Wirtgen 2500SM surface miner to mine or excavate about 1000 to 1400 metric ton of limestone per hour while crushing the limestone to form crushed carbonate of excavated and crushed limestone pieces, depending on limestone properties. In similar mining-crushing configurations, the surface miner may comprise the Wirtgen 4200SM surface miner to mine and crush about 2100 to 2700 metric ton per hour of coarsely crushed dolomite.

Comminution: The first or second mining-crushing system MC1 and/or MC2 may further crush, pulverize, grind or otherwise comminute mined carbonate from the carbonate resource L1 using one or more of a surface miner, a primary crusher, a secondary crusher, a tertiary crusher, a pulverizer, an open grinder, and/or a pressure grinder. For example, a plurality of picks on a rotating drum on one or more surface miners in miner-crusher MC1 and/or MC2 may be configured to excavate and crush the carbonate to form pieces of alkaline carbonate of less than a prescribed size. For example, about 100, 150, 200 or 300 picks per excavating drum may be variously used to form crushed limestone pieces. Picks may be in a range of 100 mm to 200 mm (4″ to 8″) in length to crush limestone such as for a large vertical kiln producing 500 to 1000 metric ton/hour. It may similarly be configured to mine and crush about 50 mm to 150 mm (2″ to 6″) limestone or dolamite pieces such as for kilns under about 700 metric ton/hour.

The excavated limestone or dolamite may be sieved or screened to separate out oversize material such as with a “grizzly.” For example, in some configurations surface mining, crushing and screening may supply the screened carbonate (limestone and/or dolomite) to about 95% less than 152 mm (6″), or 98% less than 102 mm (˜4″) or screened to less than 76 mm (˜3″) in size. The oversize material may be delivered to an oversize crushing area for the surface miner to reprocess into suitably excavated carbonate pieces. In other configurations drill, blast and excavation and/or other mining systems may be used to extract the alkaline carbonate.

A primary crusher, a secondary crusher, and/or a tertiary crusher may be used to further crush or pulverize the carbonate between the miner or surface miner and the calciner according to the application. The crushed carbonate may then be screened through a grizzle or screen to below a prescribed screen size. For example, in some configurations, the carbonate may be reduced in size and screened to form screened carbonate pieces less than about 6 mm, 13 mm, 25 mm, 51 mm, 76 mm, 102 mm, 127 mm, or 152 mm (0.25″, 0.5″, 1″, 2″, 3″, 4″, 5″ or 6″) in size depending on the type and size of calciner. For cement manufacture, carbonate materials may be further comminuted, pulverized or ground to below 100 microns, 200 microns, 500 microns, 1 mm or 2.5 mm, according to type and size of “precalciner” or rotary cement kiln used etc. Some configurations may use a pressure grinder for greater comminution efficiency.

Calcining location: Referring further to FIG. 1, the first calciner C1 may be located on, adjacent to or close to the first quarry Q1 to facilitate transport of alkaline carbonate from the first mining-crushing system MC1. The first calciner C1 may be located adjacent to, close to, or near one or more transport routes to one of a first city or population region P1 having a first population center PC1, a second population region P2 having a second population center PC2, a first industrial user IU1 and/or a second industrial user IU2. This may facilitate transport of carbonate to the calciner C1, transport alkaline oxide “byproduct” of calcining to market, and/or transport a fuel such as coal, coke, brown coal, biomass, propane, compressed natural gas, or liquified natural gas to the first calciner C1. For example, the first calciner C1 may be located close to or near a navigable waterway W1, a first or second railroad RR1 or RR2, and/or a first or second road or highway HW1 or HW2.

The first calciner C1 may be located near or close to the second quarry Q2 in the first carbonate resource L1. For example, the second quarry Q2 may be newer or larger than the first quarry Q1. Locating the first calciner C1 near the first hydrocarbon resource H1, may locate it far from a nearest remote or fifth calciner C5, which is commonly located near a third quarry Q3 and near the first major regional population or city P1 having the first population center PC1, and/or near the first industrial user IU1 of alkaline oxide such as a lime user, chemical factory, coal power plant, or cement user. The remote fifth calciner C5 is commonly near a major transport route such as a third railroad RR3, a third road or highway HW3 and/or a second navigable waterway W2 to provide easy transport to the respective first population demand market P1 or first industrial user IU1 for the calcined product. Typical alkaline oxide products of calcining carbonate may include quicklime (“lime”, “burnt lime”, or “hard burnt lime”), hydrated lime, dolomite lime (or “dololime”), mortar, construction mortar, Portland cement, Alkaline Activated Cement, dead burned magnesia, and/or magnesium hydroxide.

Calcining: Per schematic FIG. 1, in some configurations, the first calciner C1 may be a lime kiln to heat and calcine limestone and/or dolamite excavated from the first carbonate resource L1. For example, the first calciner C1 may be a vertical lime kiln located adjacent, close to, or near an existing quarry such as the first quarry Q1 and near or over the first fossil field or first hydrocarbon resource H1 comprising recoverable liquid hydrocarbons. The first calciner C1 may be a dual cylinder heat recovery lime kiln fed with crushed limestone less than about 152 mm (6″) or less than about 203 mm (8″) in size. The crushed carbonate feed may be crushed and sieved to deliver less than a prescribe size with an upper size limit in the range of about 6 mm (0.25″) to 102 mm (4″) sized limestone.

An enhancing fluid including or comprising CO2 may then be delivered from the first calciner C1 to the first pilot portion or first trial site HT1 of the first fossil resource H1. In other configurations, a second or production calciner C2 may be used to calcine crushed carbonate near the second quarry Q2. For example, a “precalciner” (such as are used to feed rotary cement kilns) may be used for the second calciner C2. In other configurations, a fourth or expansion calciner C4 may be provided near one of first and second quarries Q1 and Q2. A cement kiln may be used as the fourth calciner C4 to calcine pulverized carbonate near the second quarry Q2.

Fuel stores: As depicted in FIG. 1, in some embodiments, one or more fuel stores 881, such as fuel stockpiles or storage containers, may be provided to buffer a periodic fuel supply delivered by periodic transport of material flows. For example, buffer stores of coal may be stockpiled in one or more fuel stores 881 to provide at least twice the quantity of the periodic fuel supplied. Fuel stores 881 may be configured store two or three unit trains supply of coal. Fuel stores 881 may similarly be provided to buffer fluid fuel such as natural gas before being fed to one or more calciners for combustion.

One or more fuel stores 881 may be located near one or more of the first calciner C1 or a third calciner C3, or near or between the second calciner C2 and the fourth calciner C4. One or more fuel stores 881 may be located near transport means such as near the first or the second railroads RR1 or RR2, or near a fourth railroad RR4 extending across the first carbonate resource L1 from the first railroad RR1 and by the second quarry Q2. In some configurations one or more fuel stores 881 may be located nearby the first waterway W1, first or second highway HW1 or HW2, and/or nearby a fourth road or highway HW4 extending into the first carbonate resource L1. Fluid fuel stores 881 may be suitably located near such surface or pipeline transport means.

Carbonate stores: As further depicted in FIG. 1 one or more carbonate stores 883 may be supplied to buffer carbonate flow. e.g., carbonate stores 883 may be located near one or more calciners, such as near one or more of the first and/or third calciners C1 and C3, and near or between the second and fourth calciners C2 and C4. Carbonate stores 883 may comprise outdoor piles such as for extracted or crushed carbonate, and/or silos, such as for pulverized and/or ground carbonate.

Calcining operation: The calciner typically thermally heats or processes the alkaline carbonate to an alkaline oxide. The alkaline carbonate may be heated to greater than a prescribed minimum calcining temperature selected for the carbonate resource. Such minimum calcining temperatures are generally reported to be in the range from about 600 degrees Celsius to 950 degrees Celsius depending on operating conditions and carbonate source. For example, for some resources, the prescribed minimum calcining temperature may be 825 degrees C. for dolomite and 875 degrees C. for limestone.

The composition and pressure of the heating fluid further strongly impact the calcining rate and extent, especially the CO2 concentration. In some applications, to obtain highly reactive lime, calcining temperatures may be controlled to below 1200 degrees Celsius, below 1100 degrees Celsius, below 1000 degrees Celsius, or below 900 degrees Celsius. For other applications requiring a “dead burnt” alkaline oxide product, the calcining temperatures may be controlled to greater than a prescribed high temperature selected in the range of 1500 degrees Celsius to 2000 degrees Celsius. For example, higher temperature calcining may be used to make one of dead burnt lime, dead burnt magnesia, or combinations thereof.

The temperature of the calcining fluid may be delivered at a prescribed temperature difference above the minimum calcining temperature in the range from 10 K to 600 K. For example, in some configurations, the prescribed temperature difference may be selected as 10 K, 33 K, 100 K, 200 K, 300 K, 400 K, 500 K, 600 K or higher, above the minimum calcining temperature as desired.

In some configurations, calcining may use high temperature superheated steam to heat the crushed carbonate. This beneficially improves reaction extent and alkaline oxide reactivity. In some configurations, the heating fluid may comprise portions of steam and carbon dioxide. Other applications with oxygen or enriched oxygen combustion may form the heating fluid with portions of carbon dioxide, or carbon dioxide and nitrogen. Further heating fluid applications may use mixtures of carbon dioxide, steam, and nitrogen. The heating fluid temperature, composition, and heating duration may be configured to achieve a prescribed degree of calcination. For example, the minimum calcination degree may be controlled to one of 67%, 80%, 90%, 95%, 98% or 99%. In some configurations, the enhancing fluid formed may comprise greater than one of 50%, 67%, 80%, 90%, and 95% carbon dioxide.

In some configurations, at least 50% or 67% of the crushed alkaline carbonate may consist of carbon dioxide combined with one or more alkaline oxides such as calcium and/or magnesium, e.g., limestone, dolamite, and/or magnesite. In other configurations, alkaline carbonate may form 85%, 90%, 95% or 97% of the carbonate resource. In some configurations, the alkaline carbonate may comprise carbon dioxide combined with an oxide of lithium, sodium, and/or potassium. The alkaline oxide generated may comprise one or more of lime, mortar, burnt lime, hard burnt lime, dead burnt dolomite, construction mortar, Portland cement, lithium oxide, sodium oxide, and/or potassium oxide. In some embodiments, the alkaline oxide from calcining may be hydrated to form hydrated alkaline oxide, such as hydrated lime, hydrated dololime, magnesium hydroxide, lithium hydroxide, sodium hydroxide and/or potassium hydroxide.

Calcining & CO2 delivery rates: Referring to FIG. 1, in some configurations, the first calciner C1 may be a lime kiln processing 185 to 1850 metric ton/day of limestone and producing from 100 to 1000 metric ton/day of lime at a design production rate. For example, Calciner C1 may calcine 463, 925 or 1388 metric tons/day of limestone to make about 250, 500, or 750 metric ton/day of lime and generate about 213, 426, or 639 metric tons/day of CO2. In a further configuration, this first calciner C1 may process about 1,200 metric ton of limestone per day to produce about 650 metric ton of lime per day and generate about 554 metric ton of carbon dioxide per day at the design production rate.

Direct fuel combustion typically generates about 50.6 kg of CO2/GJ of heat using natural gas. Combustion of sub bituminous coal may generate about 96 kg of CO2/GJ of heat. By comparison, such calcining above may generate and deliver greater than 333, 285, 250, or 200 kg new CO2/GJ of heat generated (excluding CO2 in combustion gas). e.g, at 3.0, 3.5, 4.0, or 5.0 GJ/metric ton new of CO2 generated respectively (equivalent to 2.8, 3.0, 3.4 or 4.3 GJ/metric ton lime produced). Actual lime production rates may vary depending on the concentration of non-carbonate materials in the carbonate, such as in limestone, dolamite and/or magnesite, and the capacity of the hydrocarbon field to receive the enhancing fluid. Further CO2 is formed by fuel combustion and may be captured from the combustion flue gas.

Supply limestone: Referring to FIG. 1, where no carbonate resource is available about the second hydrocarbon resource H2, alkaline carbonate may be excavated from one of the first quarry Q1 and/or the second quarry Q2 in the nearby first carbonate resource L1 and transported by the first highway HW1 to the third calciner C3 near the second hydrocarbon pilot or trial site HT2. Similarly, the excavated carbonate may be transported by rail where the first railroad or rail spur RR1 is available from near first or second quarries Q1 and/or Q2 to the second hydrocarbon trial site HT2. Such transport enables operation of the calciner C3 to deliver enhancing fluid to the second hydrocarbon trial site HT2 before a pipeline PL2 may be built from the first or second calciners C1 or C2 to the second hydrocarbon trial site HT2 or before a pipeline PL4 may be built from a large remote sixth calciner C6 such as by a remote fourth quarry Q4 on a third limestone, dolomite or carbonate resource L3 near the second population center PC2, to the near the second hydrocarbon trial site HT2 and/or a second hydrocarbon production site HP2.

Buffer limestone supply: Referring to FIG. 1, in one exemplary configuration to prove up the first hydrocarbon pilot or trial site HT1 may calcine at a pilot limestone calcining rate of about 1,200 metric ton of limestone per day or about 33,000 metric ton per month. This pilot or trial calcining rate would nominally use about 876,000 metric ton of limestone over two years. A surface miner nominally excavating and crushing about 1,250 to 2,500 metric ton/hour may extract a month's worth of carbonate in 26 to 13 hours of operation. In some configurations, one month's to two month's buffer storage of mined carbonate may be provided by one day to one week of operation of the surface miner.

In some configurations, the surface miner could nominally excavate and crush a two year supply of carbonate in 30 to 15 days of two shift operation (at 30,000 to 60,000 metric ton/day), or in 60 to 30 days of single shift operation. In some configurations, the surface miner may be used to variously extract substantial carbonate resource for the carbonate stores 883. For example, such mined carbonate stores 883 may be sufficient to support 2 months, 3 months, 6 months, 12 months, 18 months, or 24 months of operation of the calciner at greater than 85% of design capacity. Such carbonate such as limestone may be extracted from one or more of the first and second quarries Q1 and Q2 in first carbonate resource L1 and transported to one or more carbonate stores 883 such as near one or more of calciners C1, C2 and C4.

Another configuration may provide for using one of the first and/or second mining-crushing systems MC1 or MC2 to extract and store sufficient limestone for the first and/or second hydrocarbon trial sites HT1 or HT2 for an extended period such as for 6 to 24 months. In a further configuration, the second surface miner MC2 may be used to excavate sufficient limestone to support one or more pilot or trial calciners and a production calciner. For example, this may support one or more trial calciners capable of processing 200 to 1,900 metric ton/day of limestone, such as the first or third calciners C1 or C3, and/or a larger production calciner capable of processing 2,000 to 20,000 metric ton/day of limestone, such as the second or forth calciners C2 or C4.

A small calciner and a large calciner together processing 4,000 to 20,000 metric ton/day of limestone may process 0.7 to 3.2 million metric ton of limestone over 6 months, or 2.9 million to 12.8 million metric tons of limestone over 24 months etc. Such novel methods would justify relocating the first or second surface miner MC1 or MC2 and leveraging such high productivity which might otherwise be impractical for small individual remotely located calciners.

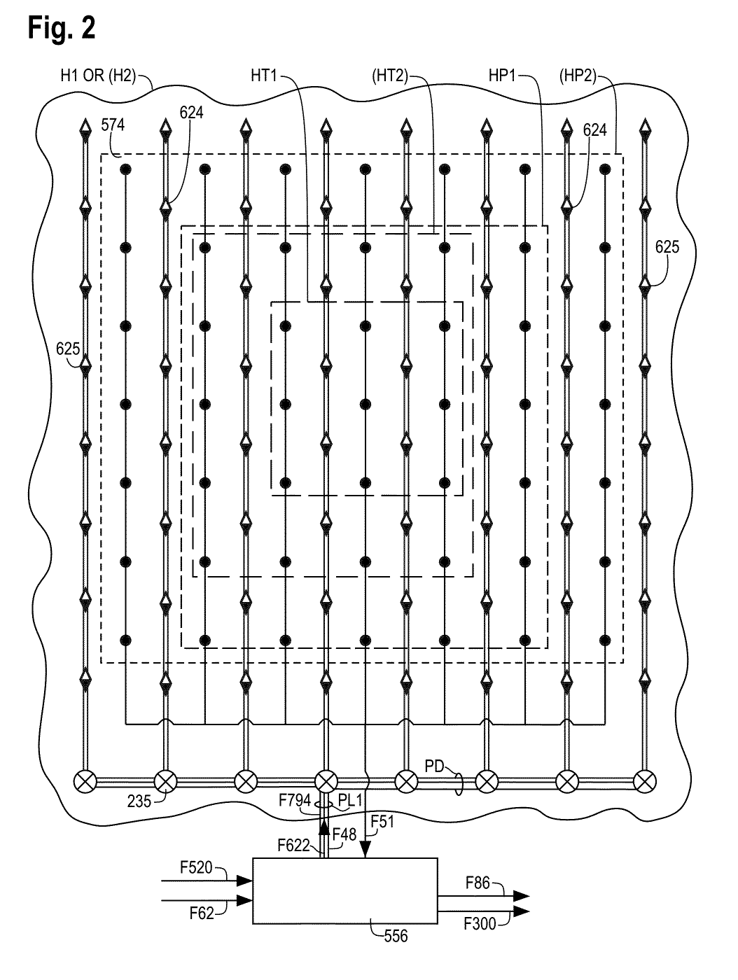

Proving CO2 Response: Referring to further detail in schematic FIG. 2, in the context of FIG. 1, an enhancing fluid F62 to enhance hydrocarbon production, generated by one or more of the first, second, third, and fourth calciners C1, C2, C3, and C4, may be delivered via the first local enhancing pipeline PL1 through a pipeline distribution system PD having fluid control valves 235 to a plurality of enhancing injection wells 624 and blocking injection wells 625 (black/white diamonds) into one or more sections of one or more of the first or second hydrocarbon resources H1 and/or (H2). For example, enhancing fluid F62 may be delivered to one of the first hydrocarbon trial site HT1 and a first hydrocarbon production site HP1 in the first hydrocarbon resource H1. Enhancing fluid F62 may be delivered for sufficient time to demonstrate an initial substantial quantifiable response of enhanced hydrocarbon production from production wells 574 (solid circles). Similarly, the first hydrocarbon trial site HT1 may be selected as adjacent to or near the first hydrocarbon production site HP1 (such as in FIG. 1).

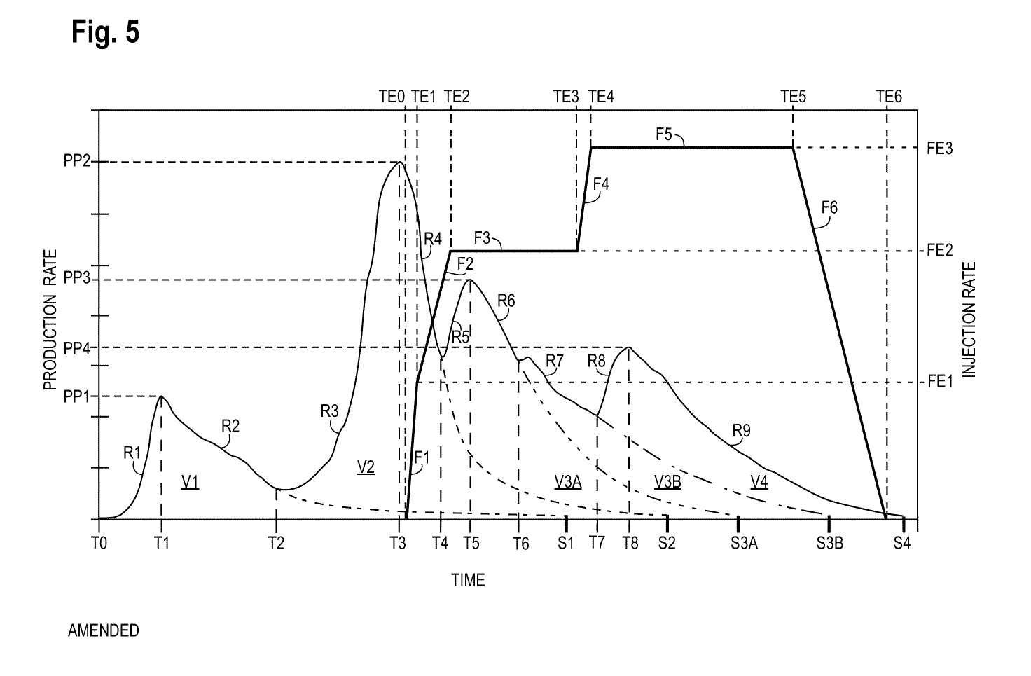

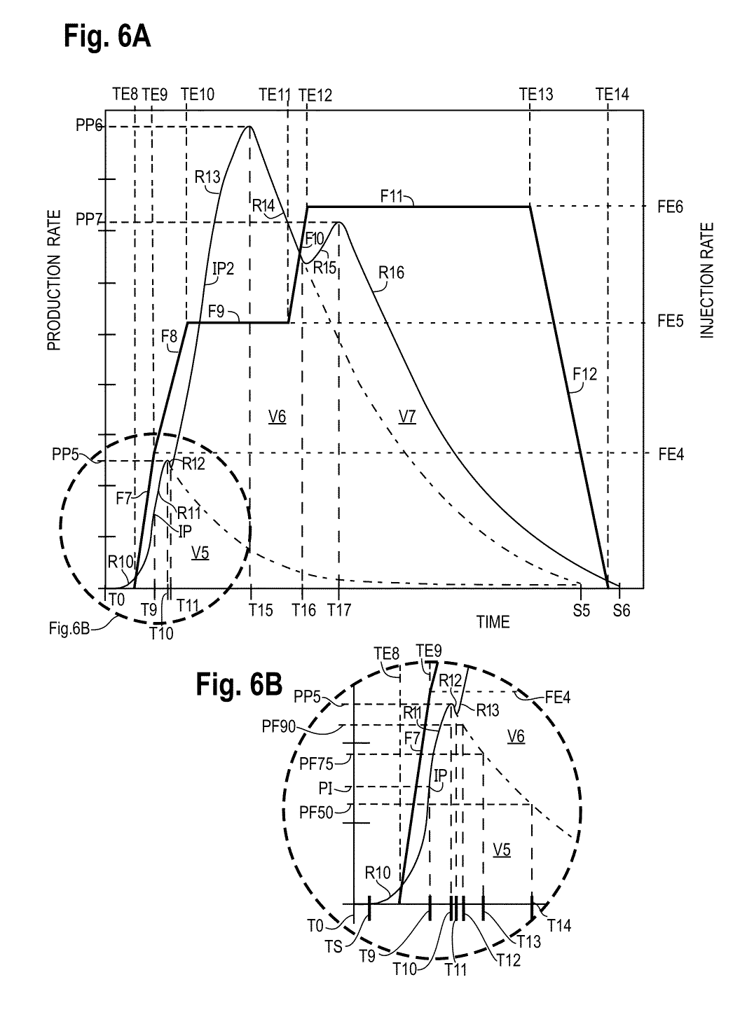

As indicated schematically in FIG. 2, enhancing fluid F62 may be delivered via a first fluid separation battery 556 and delivered as enhancing fluid F622 via the pipeline distribution system PD into a first hydrocarbon resource H1 and/or a second hydrocarbon resource (H2). As detailed below in FIG. 5, FIG. 6A and FIG. 6B, further enhancing fluid F62 may be delivered for sufficient time to show major hydrocarbon enhancement. Yet further enhancing fluid F62 may be delivered to show a near maximum hydrocarbon enhancement response for that enhancing fluid injection rate.

As further schematically superimposed in FIG. 2 further enhancing fluid F62 may be delivered via another enhancing pipeline (not shown, similar to the first enhancing pipeline PL1), the pipeline distribution system PD and injection wells 624 into, one or more of the second hydrocarbon trial site (HT2) and/or the second hydrocarbon production site (HP2) in the second hydrocarbon resource or reservoir (H2). In some configurations, one or more portions of enhancing fluids F622 comprising CO2 may be delivered from one of the first fluid separation battery 556 and/or a second separation battery (not shown) to a one or more of the second hydrocarbon trial site (HT2) and the second hydrocarbon production site (HP2). Similarly, the recovered fluid F51 from one or more of the second hydrocarbon trial site (HT2) and the second hydrocarbon production site (HP2) may be processed by one or both of the first battery 566 and the second separation battery (not shown) to separate recovered enhancing fluid F622 comprising CO2 from deliverable hydrocarbon fluid F86.

As schematically depicted in FIG. 2, in some embodiments, the first portion of the enhancing fluid F622 may be delivered through the pipeline distribution system PD to the first hydrocarbon trial site HT1 though four injection wells 624 configured in an inverted five spot pattern among nine production wells 574. Similarly, the second portion of enhancing fluid F622 may be delivered to the first hydrocarbon production site HP1 in hydrocarbon resource H1. For example, a portion of enhancing fluid F622 may be injected into twenty enhancing injection wells 624 in an inverted five spot pattern amongst thirty production wells 574 in the first production site HP1.

In similar configurations, a third portion of enhancing fluid F622 may be delivered to the second hydrocarbon trial site (HT2) in the analogous or second hydrocarbon resource (H2), with twelve injection wells 624 in an inverted five spot pattern among twenty production wells 574. For example, enhancing fluid F622 may be delivered into the second hydrocarbon trial site (HT2) covering about 3.2 square km (1.25 square miles) with wells drilled at one well per 16 ha (40 acre) spatial density. In a further configuration, a fourth portion of the enhancing fluid F622 may be delivered into thirty six enhancing injection wells 624 intermixed between forty nine production wells 574 in the second hydrocarbon production site (HP2) in the second hydrocarbon resource (H2).

While these hydrocarbon trial sites HT1 and (HT2), and hydrocarbon production sites HP1 and (HP2) are schematically shown as of differing size for fields H1 and (H2), other overlapping, adjacent, or non-overlapping configurations of variously sized trial and/or production sites may be used. Portions of enhancing fluid may be delivered in differing order. e.g., the first portion of enhancing fluid may go to the first trial site HT1, the second portion to the second trial site HT2, the third portion to the first production site HP1, and the fourth portion to the second production site HP2. Similarly the trial and/or production sites may be configured with other geometric configurations. Higher or lower well densities may be use such as one well per 4, 8, 12, 16, 20, 24, or 32 ha (10, 20, 30, 40, 50, 60 or 80 acres) according to the quality and/or original oil in place (OOIP) of the hydrocarbon resource. One or more other ratios of enhancing injection wells to production wells may be used. e.g., 1 to 4 times as many production wells as injection wells, 5 to 10 times, 11 to 20 times, 21 to 40 times, or more than 51 times as many production wells as trial wells.

As FIG. 2 further schematically depicts, a produced fluid F51 from production wells 574 may be delivered to the first fluid separation battery 556 to separate out the marketable hydrocarbon fluid F86 and deliver it to the market. Some configurations may further separate recovered enhancing fluid F622 from the produced fluid F51 and return a portion of it to the enhancing pipeline PL1 and the pipeline distribution system PD with valves 235 controlling injection of enhancing fluid F622 and an enhancing aqueous fluid F48, such as water, surfactant containing water or aqueous foam, into injection wells 624. (In some configurations, a pressurizing blocking fluid F794, such as flue gas, cooled flue gas, and/or generator exhaust, may be delivered into blocking injection wells 625).

Some configurations may combine recovered enhancing fluid F622 with further enhancing fluid F62 and then deliver it to the pipeline PL1 and distribution system PE for reinjection. In some configurations, an aqueous supply fluid F520, such as ground water or surface water, may delivered to the first fluid separation battery 556 to form and deliver enhancing aqueous fluid F48 through the first pipeline PL1 and the pipeline distribution system PD to inject into injection wells 624. Similarly, the first fluid separation battery 556 may recover aqueous fluid from the produced fluid F51 and redeliver a portion of the recovered aqueous fluid with makeup aqueous supply fluid F520 to deliver aqueous fluid F48 to the fluid enhancing injection wells 624 via the pipeline PL1 and the pipeline distribution system PD.

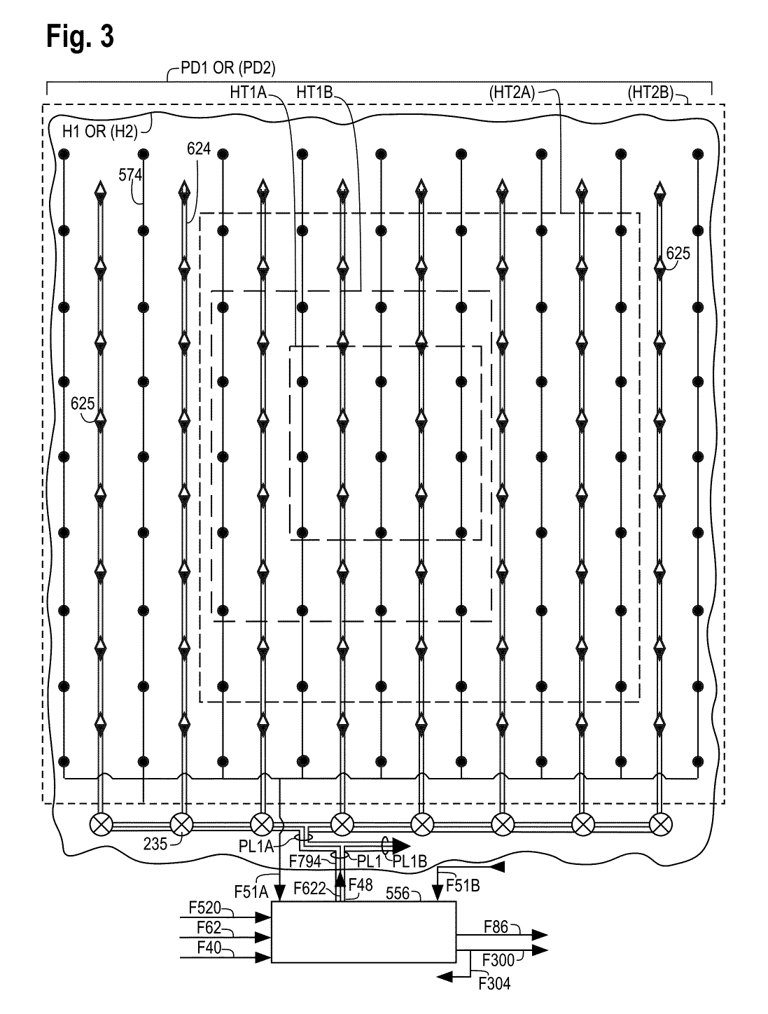

The methodology shown in schematic FIG. 2 may be extended to larger sizes in schematic FIG. 3 with symbolic indication that such distributions of enhancing injection wells 624, blocking injection wells 625, and production wells 574, could be used in two geographically separated recovery regions. For example, FIG. 3 schematically indicates delivery of enhancing fluid F622 via primary sub-pipeline PL1A though a primary or first pipeline distribution system PD1 into the first hydrocarbon trial site through small primary or medium alternate first hydrocarbon trial site configurations HT1A or HT1B in the first hydrocarbon resource H1. Enhancing fluid may similarly be delivered to the second hydrocarbon trial site via an alternate or second sub-pipeline PL1B through the alternate or second pipeline distribution system (PD2) similar or larger medium primary or larger alternate second hydrocarbon trial site configurations (HT2A) or (HT2B) on the second hydrocarbon resource (H2) (symbolically shown as overlapping the first hydrocarbon resource H1).

As FIG. 3 schematically depicts, produced fluids F51A from production wells 574 may be delivered to a first fluid separation battery 556 to separate out the marketable hydrocarbon fluid F86 and deliver it to the market. Some configurations may utilize a second fluid separation battery (not shown) such as to process fluids from one of the first hydrocarbon production HP1, in the first hydrocarbon resource H1, the second hydrocarbon trial HT2 and the second hydrocarbon production site HP2 in the second hydrocarbon resource (H2). Some configurations may further recover enhancing fluid F622 and deliver it to the enhancing pipeline PL1 for delivery through the first or primary sub-pipeline PL1A to the primary or first pipeline distribution system PD1 with valves 235 controlling injection of enhancing fluid F622 into enhancing injection wells 624 (and of blocking fluid F794, such as flue gas or nitrogen, into blocking injection wells 625).

Some configurations may combine recovered enhancing fluid F622 with further enhancing fluid F62 and then deliver it to the enhancing pipeline PL1, through the primary sub-pipeline PL1A, and into the first pipeline distribution system PD1 for reinjection. In similar embodiments, a combustion system utilizing thermal diluent F40 such as water or flue gas may be used to form and deliver a process gas comprising CO2 as part of the enhancing fluid F622 to inject into injection wells 624.

In some configurations, aqueous supply fluid F520 may similarly be provided to deliver or replenish aqueous fluid F48 through the enhancing pipeline PL1 and the alternate sub-pipeline PL1B into the second pipeline distribution system shown schematically superimposed as (PD2), to inject into enhancing injection wells 624. Similarly, the first fluid separation battery 556 may recover aqueous fluid from the produced fluid F51 and redeliver a portion of the recovered aqueous fluid with aqueous supply fluid F520 to deliver aqueous fluid F48 to the enhancing injection wells 624 via the enhancing pipeline PL1 the primary sub-pipeline and first distribution system PL1 and PD1.

Second/remote trial site: As schematically depicted in FIG. 3, one or more enhancing fluids F622, blocking fluid F794 and/or aqueous fluid F48 may be delivered through the alternate sub-pipeline PL1B and the second pipeline distribution system (PD2) into the base second hydrocarbon trial site (HT2A) in the second hydrocarbon site (H2) (depicted schematically as overlapping). For example, enhancing fluids F622, and/or aqueous fluid F48 may be delivered through 30 enhancing injection wells among 48 production wells in an inverted five spot pattern. The effectiveness of delivering enhancing fluid to such injection fields may be enhanced by delivering blocking fluid F794 through blocking injection wells 625 surrounding the enhancing injection wells 624 delivering enhancing fluid.

In some configurations, produced fluids from the second hydrocarbon resource (H2) may be processed in a second separation battery (not shown). Produced fluids F51B from the second hydrocarbon resource may also be delivered to the first separation battery for separation into liquid product fluid F86 comprising a hydrocarbon, and a first gaseous product fluid F300 comprising a hydrocarbon, and a second gaseous product fluid F304 comprising a hydrocarbon.

Expansion: Referring further to FIG. 1, in some embodiments the production or second calciner C2 may be configured to process carbonate from the second quarry Q2 in the first carbonate (limestone or dolomite) resource L1. This second calciner C2 may provide enhancing fluid via the first pipeline PL1 to the first hydrocarbon trial site HT1.

Extending transport means: In some configurations, a third pipeline PL3 may be provided to deliver enhancing fluid from the second calciner C2 to the first hydrocarbon production site HP1. A second pipeline PL2 may be configured to deliver enhancing fluid from the second calciner C2 to the second hydrocarbon trial site HT2 in the second hydrocarbon resource H2. A third pipeline PL3 may be provided to deliver enhancing fluid from the production second calciner C2 to one or more of the first hydrocarbon trial site HT1 and first hydrocarbon production site HP1. Two or more of the first, second and third pipelines, PL1, PL2 and/or PL3, may be interconnected to facilitate flexible delivery and/or improve reliability.

Per FIG. 1, in some configurations the production fourth calciner C4 may be located on or close to the second quarry Q2 in the first carbonate or limestone resource L1 near the first hydrocarbon resource H1. A rail spur RR4 may be extended from the first railroad RR1 past the second calciner C2, to the production calciner C4. In some configurations, an overhead or elevated “string” rail system with periodic towers may be provided to transport crushed carbonate from one or more the first and second quarries, Q1 and Q2, to one or more of the first, second, third, and fourth calciners C1, C2, C3 and/or C4. This method beneficially requires less civil works and can be installed faster than conventional railroads with minimal traffic disruption when traversing other means of transport.

Conveyors & pipelines: In other configurations, a conveyor system (not shown) following routes similar to the pipelines may similarly transport crushed carbonate from one or more of the first and second quarries, Q1 and Q2, to one or more of the first, second, third, and fourth calciners C1, C2, C3 and/or C4. e.g., a pipeline PL5 may be extended from the second pipeline PL2 to the production fourth calciner C4. This may enables delivery of enhancing fluid from one or more of the first, second, third, and fourth calciners, C1, C2 and C4, to one or both of the first production site HP1 in the first hydrocarbon region H1, and the second hydrocarbon production site HP2 in the second hydrocarbon region H2.

Relative positioning: Referring further to FIG. 1, in some embodiments, a first local trial CO2 delivery distance, to the center of the first hydrocarbon trial site HT1, having an enhancing injection well weighted first enhancement location, from the local first calciner C1 at the first calcining site, may be less than 67% of a first remote CO2 delivery distance, to the first enhancement or hydrocarbon trial site HT1 from the remote fifth calciner C5 at a remote calcining site, having an equal or greater remote CO2 generating capacity than the local CO2 generating capacity of the local first calciner C1. In other configurations, the first local trial CO2 delivery distance to the first hydrocarbon trial site HT1 may be less than 50% of the first remote CO2 delivery distance from the remote fifth calciner C5.

In some embodiments, a first local production CO2 delivery distance, to a center of the first hydrocarbon production site HP1 from the second calciner C2 at a second calcining site, may be less than 50% of a second remote CO2 delivery distance, to the center of first hydrocarbon production site HP1 from the location of a large remote sixth calciner C6 at a remote calcining site, wherein the large remote sixth calciner C6 has an equal or greater remote CO2 generating capacity than the local CO2 generating capacity of the local second calciner C2.

In some embodiments, a local mean CO2 delivery distance, to a first hydrocarbon center HC1 of the first hydrocarbon resource H1, weighted by an oil in place, from the mean of locations of the first calciner C1 location and the second calciner C2, may be less than 40% of a remote mean CO2 delivery distance to the first hydrocarbon center HC1 of hydrocarbon resource H1 from the mean of the location of the nearest remote or fifth calciner C5 and the location of the next nearest or sixth calciner C6, together having an equal or greater CO2 generating capacity than the combined capacity of the first calciner C1 and the second calciner C2. In other configurations the local mean CO2 delivery distance may be less than 33% of the remote mean CO2 delivery distance.

Referring further to FIG. 1, in some configurations, a first local CO2 delivery distance to the first resource weighted hydrocarbon center HC1 of the first hydrocarbon resource H1 from the second calciner C2 may be less than a prescribed CO2 alkali demand distance. For example, the prescribed CO2 delivery distance may be less than 65% of a remote alkali demand distance for alkaline oxide DADP, from the first hydrocarbon center HC1 to a demand weighted alkali demand center ADP of the first remote population region P1 and the second remote population region P2.

In another configuration, a first local CO2 delivery distance from the site of the second calciner C2 to the first enhancing injection well weighted enhancement location may be less than 60% of a scalar average alkali demand distance (DADC), of an average of one or more absolute scalar distances from the enhancing injection well weighted enhancement location H1 to a combined alkali demand (ADC) of one or more alkali demands selected from one or more population demand centers, and one or more industrial demand center, having the combined alkali demand for alkaline oxide greater than a design alkali generation rate of alkaline oxide generation achievable by calcining carbonate in calciner C2.

In a further configuration, per FIG. 1, the plurality of calciners at calcining sites may be operable to generate enhancing fluid for injection and mobilizing hydrocarbon at a plurality of hydrocarbon enhancement sites, wherein the production well weighted production distance, to the first mean enhancement center of the plurality of hydrocarbon enhancement sites, from a mean calcining center CCT of the plurality of calcining sites near the first hydrocarbon resource, is less than 50% of the average alkali demand distance, of the demand weighted absolute scalar distances to the first mean enhancement center from the plurality of population and/or industrial alkaline oxide demand locations having collectively am equal or greater alkaline demand than the plurality of calcining sites.

In some configurations, a mean CO2 enhancing fluid delivery distance for enhancing fluid comprising CO2 to the first resource weighted hydrocarbon center HC1 of first hydrocarbon resource H1 from a production weighted calcining center CCT of a plurality of nearby operating calciners having a combined design alkali generating capacity to produce alkaline oxide, may be less than 50% of a remote mean demand distance CM of an alkali demand weighted average of absolute scalar distances from the first hydrocarbon center HC1 to an alkali demand weighted market CM of a plurality of one or more of the first population center PC1, the second population center PC2, and the first industrial user IU1 and the second industrial user IU2, having a alkali demand greater than the combined design alkali generating capacity of the plurality of nearby operating calciners. For example, the production weighted calcining center CCT may be the production weighted location of the plurality of two or more of the first, second, third, and fourth calciners C1, C2 and C4 as they are put into production.

In some configurations, per FIG. 1, a mean alkali demand distance, of the scalar average absolute distances from an area weighted mean enhancement location HE1, of the first hydrocarbon trial site HT1 and the first hydrocarbon production site HP1, to one or more remote alkali demands for alkaline oxide, comprising one or more of population centers and one or more industrial users, may be greater than a production distance, to the first mean enhancement location HE1 from the first mean supply location CS1 of the carbonate supply sites quarry Q1 and quarry Q2, wherein the remote alkali demand is greater than the combined local calciner alkaline oxide design production capacity. For example, nearby operating calcining sites may include two or more of the first, second, third, and fourth calciners, C1, C2, C3, and C4, as they are put into production and produce alkaline oxide comprising calcium or magnesium.

In some configurations a carbonate of calcium and/or magnesium may be mined at one or more of the first mining site or quarry Q1 and/or the second mining site or quarry Q2 in the first carbonate resource L1, at a mining distance less than a prescribed mining distance from the first hydrocarbon enhancement site HT1 in a first hydrocarbon resource H1. In some configurations, the prescribed mining distance may be less than one of 40%, 50% or 60% of a remote calcining distance to one of remote calciners C5 and/or C6 having an equal or greater design calcining capacity than a design calcining capacity of the respective trial calciner C1, production calciner C2 or C4, or a combination of such local calciners.

Regional pipelines: Referring to FIG. 1, in some embodiments, a regional or fourth CO2 pipeline PL4 may be provided from a large remote production sixth calciner C6 by the remote fourth quarry Q4 in the third limestone or carbonate resource L3 near the second population center PC2 of the second population P2 to one or more of the second hydrocarbon trial site HT2 and the second hydrocarbon production site HP2 in the second hydrocarbon region H2 etc. For example, the fourth pipeline PL4 may be provided after proving enhanced hydrocarbon production by one or more of the first hydrocarbon trial site HT1 and the second hydrocarbon trial site HT2 etc. In some configurations the fourth pipeline PL4 may be provided after proving enhanced hydrocarbon production in one or more of the first hydrocarbon production site HP1 and second hydrocarbon production site HP2.

Some configurations may provide for extending the second pipeline PL2 from the second calciner C2 to the second hydrocarbon trial site HT2 which may be less than the length of the fourth pipeline PL4 from the large remote sixth calciner C6 to the second hydrocarbon trial site HT2. Similarly, in some configurations, the distance from production second calciner C2 to a second hydrocarbon center HC2 of the second hydrocarbon region H2 is less than the distance from the second hydrocarbon center HC2 to the the second population center PC2 of the second population P2 near the sixth calciner C6.

Blocking wells: Referring to FIG. 2 and FIG. 3, in some configurations, outer blocking injection wells 625 may be configured outside of the region comprising production wells 574. For example, 28 blocking injection wells 625 may be used to surround 36 enhancing injection wells 624 and 49 production wells 574 in the second hydrocarbon production site (HP2) as shown in FIG. 2. These outer or blocking injection wells 625 may be initially used as blocking wells by delivering blocking fluid F794, such as flue gas, cooled flue gas, and/or generator exhaust, controlled by valves 235, to reduce the CO2 outward diffusion loss.

Such blocking injection wells 625 may deliver blocking fluid F794, such as a VASTgas or flue gas formed by near stoichiometric fuel combustion diluted with water and/or CO2, to provide an inexpensive blocking gas comprising nitrogen and CO2 tuned for little oxygen and little carbon monoxide (CO). For example, blocking fluid F794 may be delivered to twelve blocking injection wells 625 immediately surrounding four enhancing injection wells 624 and nine production wells 574 of the first hydrocarbon trial site HT1. Similarly, delivering blocking fluid F794, may be delivered to eighteen blocking injection wells 625 surrounding twelve enhancing injection wells 624 and twenty production wells 574 of the second hydrocarbon trial site HT2. This may include corresponding configuration of the first pipeline distribution system PD1 with valves 235, and/or corresponding configuration of valves 235 in the second pipeline distribution system (PD2).

Converting blocking to enhancing wells: Referring further to FIG. 3, in some configurations, the outer blocking injection wells 625 may be reconfigured to enhancing injection wells 624 by changing from delivery of blocking fluid F794, such as VASTgas, to delivering enhancing fluid F622. The base second hydrocarbon trial site configuration HT2A may be converted to the alternate second trial site configuration HT2B by changing from delivering blocking fluid F794 to the blocking injection wells 625 of the initial configuration HT2A of the second hydrocarbon trial site to delivering enhancing fluid F622 into those injection wells to act as enhancing injection wells in the alternate configuration HT2B. For example, the base second hydrocarbon trial configuration HT2A shown as 30 (5×6) enhancing injection wells 624 with 42 (6×7) production wells 574, may be changed to the alternate second hydrocarbon trial configuration HT2B with 64 (8×8) enhancing injection wells 624 and 81 (9×9) production wells. Further production wells 574 may be provided surrounding the enhancing injection wells 624 (converted from blocking injection wells 625).

This conversion from blocking injection wells 625 to enhancing injection wells 624 may be controlled in proportion to the available delivery of enhancing fluid comprising CO2 as the first fluid separation battery 556 begins and increasingly recovers and recycles enhancing fluid comprising CO2. Such conversion from blocking to enhancing injection wells may be performed with increasing CO2 supply, such as by connecting another calciner to deliver more CO2. Valves 235 may be reconfigured in one or both of the first and second pipeline distribution systems PD1 and PD2 to form a new set of surrounding outer injection wells, to be used as blocking injection wells 625, to deliver blocking fluid F794, to surround the inner converted blocking to enhancing injection wells 624.

Conversely, in some startup or endgame operations, enhancing injection wells 624 may be changed from injecting enhancing fluid F622 to blocking injection wells 625 injecting blocking fluid F794. e.g., this may be done during startup as the fluid conductivity of the hydrocarbon field increases as hydrocarbon production increases. As production progresses, earlier or central enhancing injection wells 624 may be reconfigured to blocking injection wells 625. Delivery of blocking fluid F794 to such depleted or mature wells may be used to focus delivery of enhancing fluid F622 into more productive hydrocarbon regions.

Transport Costs: Referring further to FIG. 1, in some configurations, the calcining EOR system 10 may be configured to where a weighted lime transport cost from the production weighted calcining center CCT to the demand weighted market center CM is greater than a cost of CO2 pipeline transport from calciner C6 to a production weighted hydrocarbon center HCT of enhanced hydrocarbon production in the first and second hydrocarbon resources H1 and H2. Evaluation of transport costs may use cost rates published by government or industrial sources such as National Transportation Statistics published by the Research and Innovation Technology Administration (RITA) of the US Bureau of Transport Statistics, and the Association of American Railroads (AAR).

For example, RITA (2011) reports specific transport costs (current ¢/ton-mile) as: Truck 16.54 (2007), Class I Rail 3.33 (2010), Barge 1.83 (2004), Oil pipeline 1.76 (2009). McCoy (2009 FIG. 2.10) reports levelized transport costs for CO2 ranging from about 1.1 ¢/metric ton-mile to 5.8 ¢/metric ton-mile for 1 to 10 million metric ton/year at 160 km (100 miles) (2004 US dollars) at design capacity. Energy costs may similarly be used to compare transport costs. For example, RITA documents US Class 1 Rail transport energy intensity of 188 kJ/revenue t-km (287 BtU/revenue freight ton-mile) in 2010.

Proving CO2 Response: Referring to FIG. 2, enhancing fluid F62 comprising CO2 produced by one or more of calciners C1, C2, C3 and C4 may be delivered via the pipeline distribution system PL1 to the plurality of enhancing injection wells 624 in the section of the hydrocarbon resource enhancement or hydrocarbon trial site HT1 of the hydrocarbon resource H1. This may be performed for sufficient time to demonstrate or prove a quantifiable response of enhanced hydrocarbon production from a portion of production wells 574, or to show a near maximum response for that enhancing fluid injection rate from those production wells 574.

A typical distribution well distribution for the first hydrocarbon trial site HT1 is shown in FIG. 2 with four enhancing injection wells 624 configured in an inverted five spot pattern among nine production wells 574. In some configurations, the enhancing fluid F622 may be delivered to nine enhancing injection wells 624 in an inverted five spot pattern among sixteen production wells 574 for the second hydrocarbon trial site (HT2). For example, enhancing fluid F622 may be delivered in the second hydrocarbon trial site (HT2) having 2.59 sq km (one square mile section) with production wells 574 drilled at one well per 16 ha (40 acre) spatial density. Other injection and production configurations may similarly be used.

In such configurations, further injection wells may be configured outside around the production wells 574. These outer injection wells may be initially used as blocking injection wells 625 by delivering a blocking fluid to reduce one of lower enhancement rate, and/or the CO2 loss rate from CO2 outward diffusion. These blocking injection wells 625 may deliver blocking fluid F794, such as VASTgas formed by near stoichiometric fuel combustion diluted with water and/or CO2, to provide an inexpensive blocking gas comprising nitrogen and CO2 tuned for little oxygen and little CO. For example, VASTgas may be delivered as blocking fluid F794 to the sixteen or twenty blocking injection wells 625 immediately surrounding the second hydrocarbon trial site (HT2).

Enhancing tertiary production: Referring to schematic FIG. 5, in some embodiments, enhancing fluid may be delivered to mobilize hydrocarbon and provide one or more of increased tertiary CO2-EOR hydrocarbon production V3A, V3B, and/or quaternary CO2 ROZ hydrocarbon production V4. For example, oilfield production may begin at time T0 with the primary production V1 from direct pumping increasing at a rising hydrocarbon production rate R1 to a first production peak PP1 at first peak time T1. Primary production may then continue at a declining hydrocarbon production rate R2. e.g., dropping to 25% of primary production at time T2. Without enhancement, such primary production would be expected to continue declining until field shutdown at a time S1. This would result in the primary hydrocarbon or oil recovery V1. For example, the primary oil recovery V1 may cover the integrated production of primary production commencing at time To of the rising first primary hydrocarbon production rate R1 to first production peak PP1 followed by the declining primary hydrocarbon production rate R2 until primary production shutdown at time S1.

Secondary production V2 may begin at time T2 such as by proceeding with water flooding. This may cause a secondary hydrocarbon production rate R3 to break with an accelerating rise to break from the declining curve R2, and rise to a second production peak PP2 at time T3 followed by declining secondary production at a declining secondary hydrocarbon production rate R4. With just water flooding, this secondary production might continue declining at a declining hydrocarbon production rate R4 to a secondary production shutdown at time S2. This would result in a secondary enhanced oil recovery V2. For example, the secondary enhanced oil recovery V2 may cover the integrated production from secondary production commencement at time T2 to shutdown at time S2 between the declining primary hydrocarbon production rate R2 and the increasing secondary hydrocarbon production rate R3 and the declining secondary hydrocarbon production rate R4.

Referring to schematic FIG. 5, (not the upper axis and the right axis), in some configurations, injection of a first enhancing fluid injection F1 comprising CO2 may begin at an initial enhancement time TEO rising to a first fluid enhancement injection rate FE1 at a first enhancement time TEL e.g., first enhancing fluid injection F1 may increase to the design CO2 generation rate of CO2 generation from calcining carbonate near a design calcining rate. Further enhancing fluid may then be delivered at an increasing second enhancing fluid injection F2 from the first fluid enhancement injection rate FE1 at enhancement time TM to a second fluid enhancement injection rate FE2 at a second enhancement time TE2. Enhancing fluid injection may continue with a third enhancing fluid injection F3 at the second fluid enhancement injection rate FE2 from the second enhancement time TE2 to a third enhancement time TE3.

For example, the second enhancing fluid injection F2 may increase to the third enhancing fluid injection F3 as increasing hydrocarbon fluid comprising enhancing fluid is produced, and the enhancing fluid is separated and a portion of the separated enhancing fluid is reinjected. Enhanced hydrocarbon recovery may be recognized at a time T4 with a change from a declining hydrocarbon production rate R4 to an increasing tertiary hydrocarbon production rate R5. Such enhancement may produce enhanced tertiary hydrocarbon production V3A by CO2-Enhanced Oil Recovery (EOR) such as in a mature oil field. For example, in some configurations tertiary oil production may increase at an initial rising tertiary hydrocarbon production rate R5 from the time T4 to a tertiary third production peak PP3 at a time T5. Then this initial tertiary production may decline at a declining tertiary hydrocarbon production rate R6 to a time T6.

Further to such configurations in FIG. 5, continuing steady delivery of enhancing fluid at the third enhancing injection F3 at the second fluid enhancement injection rate FE2 after time T6 might then continue tertiary production at the declining hydrocarbon tertiary production rate R6 (extrapolated) to an initial tertiary shutoff at time S3A. This may result in initial tertiary enhanced oil recovery V3A as the integrated production from commencement at time T4 through to shutdown at time S3A and between declining secondary hydrocarbon production rate R4 and the enhanced rising hydrocarbon production rate R5 and the declining hydrocarbon production rate R6.

Extending tertiary wells to ROZ: In some configurations, per schematic FIG. 5, the effectiveness of enhancing fluid injection may then be increased by extending enhancing fluid injection wells, infilling injection and/or production wells, and/or adding horizontal injection and/or production wells. Such injection and/or production well enhancement may increase the tertiary production to a second rising and/or falling tertiary hydrocarbon production rate R7 from time T6 to time T7. For example, enhanced tertiary hydrocarbon production rate R7 by be obtained by increasing the enhancing fluid flow rate through extended or enhanced injection wells and/or through Water Alternating Gas (WAG) enhancement.

In some configurations, continuing such third enhancing fluid injection F3 at the second fluid enhancement injection rate FE2 would then continue a second tertiary enhancement at the declining hydrocarbon production rate R7 to a shut down of such tertiary enhanced production at time S3B. This would result in an final tertiary enhanced oil recovery V3B as the integrated production from commencement at time T6 through to shutdown at time S3B and between declining initial tertiary hydrocarbon production rate R6 (then extrapolated) and the increased enhanced oil production rates R7, followed by declining tertiary hydrocarbon production rate R7 (then extrapolated) to shutdown at S3B.

Quaternary enhanced production: Referring further to schematic FIG. 5, in further configurations, injection wells may be deepened and/or additional deeper injection wells drilled to increase CO2 enhancement delivery depth beyond the mature oil field depth down into a lower (or intermediate) naturally water swept Residual Oil Zone (“ROZ” or “brownfield ROZ”). The enhancement fluid injection rate may be further increased along a rising fourth enhancing fluid injection F4 from time TE3 to a fifth enhancing fluid injection F5 at a fluid enhancement injection rate FE3 from an enhancement time TE4 to enhancement time TE5 for enhancement of the “brownfield ROZ” hydrocarbon resources.

Such initial quaternary enhanced production may be followed by reducing enhancing fluid delivery at a declining enhancing fluid injection F6 until shutdown at time TE6. Such “quaternary” enhanced hydrocarbon production rate may then increase at a rising hydrocarbon production rate R8 from time T7 to a quaternary fourth production peak PP4 at time T8 followed by declining quaternary production at a declining hydrocarbon production rate R9 until shutting down enhanced quaternary hydrocarbon production at time S4.

Such “endgame” or quaternary enhancement may result in a quaternary enhanced oil recovery V4 as the integrated production from commencement at time T7 through to shutdown at time S4 and between declining final tertiary hydrocarbon production rate R7 and the higher increasing quaternary hydrocarbon production rate R8 to time T8 followed by the declining quaternary production at declining hydrocarbon production rate R9 to the end of production at S4.

Primary CO2 enhancement: Referring to a schematic potential enhanced hydrocarbon production shown in FIG. 6A with further detail in FIG. 6B, in some embodiments, delivery of enhancing fluid may begin before water would conventionally be injected (which would develop secondary production with a secondary production peak and decline such as shown in FIG. 5 and described above). For example, in some configurations, operations may start at time T0 followed by primary production beginning along an accelerating hydrocarbon production rate R10 up to a primary production inflection rate P1 at a primary production inflection point IP at time T9 followed by further production rising at a decelerating hydrocarbon production rate R11 to a fifth or low CO2 primary production peak PP5 of hydrocarbon at time T10 after which it continues at a declining hydrocarbon production rate R12.

In such configurations, a seventh enhancing fluid injection F7 may begin at an enhancement time TE8, after a start of operations at T0 and before a primary hydrocarbon production decline along declining hydrocarbon production rate R12 reaches a flow rate PF50 at time T14 when production extrapolated from the declining hydrocarbon production rate R12 have dropped to about 50% of the fifth or low CO2 primary production peak PP5 of hydrocarbon. Such primary enhancement may begin before about twice the remaining primary hydrocarbon production (or remaining recoverable Oil In Place) as the common practice of waiting until primary production has declined to about the 25% of the primary peak (such as shown in FIG. 5). Such delivery of seventh enhancing fluid injection F7 may enhance production rate causing it start rising at time T11 from the declining hydrocarbon production rate R12 with an accelerating rate to a rising hydrocarbon production rate R13.

Referring to FIG. 6A and FIG. 6B, in some configurations, the seventh enhancing fluid injection F7 may rise to a fourth fluid enhancement injection rate FE4 at enhancement time TE9. For example, the seventh enhancing fluid injection F7 may rise as a calciner production of CO2 is increased towards its design capacity while enhancement fluid delivery is constrained by design hydrocarbon enhancing fluid delivery pressure being kept within a prescribed range below safety limits and resource pressure limits. For example, enhancing fluid delivery pressure may be kept within 60%, 75%, or 90% of the design safety limit.

In another configuration, the seventh enhancing fluid injection F7 may begin at time TE9 before primary hydrocarbon production declines along hydrocarbon flow rate R12 to a flow rate PF75 at time T13 at a production level of 75% of the fifth or low CO2 primary production peak PP5. In a further configuration, the seventh enhancing fluid injection F7 may begin before primary hydrocarbon production declines along declining hydrocarbon production rate R12 to a flow rate PF90 at time T12 at a production level of 90% of the fifth or low CO2 primary production peak PP5.

Referring further to FIG. 6A with detail in FIG. 6B, such enhancing fluid injection may increase from the seventh enhancing fluid injection F7 to along an increasing eighth enhancing fluid injection F8 from the fourth fluid enhancement injection rate FE4 at enhancement time TE9 to a fifth fluid enhancement injection rate FE5 at enhancement time TE10. Enhancing fluid injection may then continue along a ninth enhancing fluid injection F9 at the fourth fluid enhancement injection rate FE5 to an enhancement time TE11. One or both of the increasing enhancing fluid injections F7 and F8 may increase hydrocarbon production from the declining hydrocarbon production rate R12 to the rising hydrocarbon production rate R13 at time T11. One or more of such delivery of enhancing injections F7, F8, and F9 may result in increasing enhanced hydrocarbon production rate R13 rising to a sixth or high CO2 enhanced primary production peak PP6 at time T15, followed by a declining hydrocarbon production rate R14.

Referring to FIG. 6, with detail in FIG. 6B, in context of FIG. 5, such enhancing fluid delivery may beneficially enhance hydrocarbon recovery along the rising hydrocarbon production rate R13 which may reach the sixth or high CO2 enhanced primary production peak PP6 at a time T15 followed by a declining hydrocarbon production rate R14. The high CO2 enhanced primary production peak PP6 may be higher than the earlier fifth or low CO2 primary production peak PP5 at time T10. Such high CO2 enhanced primary production peak PP6 may be greater than one of 125%, 150% and 175% of the fifth or low CO2 primary production peak PP5. In some configurations, the enhanced production volume V6 above primary hydrocarbon production rates R10, R11, and R12 and below hydrocarbon production rates R13 and R14 extrapolated to end point S5 may be greater than 150% of the primary production V5 under primary enhance hydrocarbon production rates R10, R11, and R12 extrapolated to shutdown at end point S5.

This high CO2 enhanced primary production peak PP6 may be higher than one or more of the conventional first or primary production peak PP1, and the second or secondary production peak PP2 resulting from conventional primary production or water flooding such as shown in FIG. 5. The high CO2 enhanced primary production peak PP6 may further be higher than one of the tertiary production peak PP3 and the quaternary production peak PP4 obtained by delivering enhancing fluid comprising CO2 after conventional primary and water enhanced recovery, such as shown in FIG. 5 and described above.

Early primary CO2 enhancement: Referring further to FIG. 6A and detailed FIG. 6B, in some embodiments, the rising seventh enhancing fluid injection F7 may begin at a time TE8 rising to the fourth enhancement fluid injection rate FE4 at time TE9 while the primary production is still rising and before it reaches the fifth or low CO2 primary production peak PP5. In some configurations the initially rising hydrocarbon production rate R10 may increase at an accelerating rate after the starting time T0 until reaching a first inflection point IP in the production rate at time T9. After this inflection point IP, the rising hydrocarbon production rate R11 may continue to increase but with a decelerating acceleration rate.

In some configurations, seventh enhancing fluid injection F7 may begin during this decelerating period in the rising hydrocarbon production rate R11. The seventh enhancing fluid injection F7 delivered at a rising rate may again increase the rate of enhanced hydrocarbon production to the hydrocarbon production rate R11, rising at an accelerating rate. Similarly, rising delivery of eighth enhancing fluid injection F8 after time TE9 may change the rising hydrocarbon production rate R13 have an accelerating rate after the first inflection point IP between hydrocarbon production rates R10 and R11 and the second inflection point IP2 in hydrocarbon production rate R13.

Such a change in curvature of one of the rising hydrocarbon production rate R11 from a decelerating to an accelerating rise, would evidence enhanced production from one of enhancing fluid injection F7 and F8. Changing decelerating rise of hydrocarbon production rate R11 to accelerating rise of hydrocarbon production rate R13 also evidences enhanced production. Such enhancing fluid injection during the hydro-carbon production rate R11 may begin before one of 200%, 300%, or 400% of the duration from the commencement of operations at time T0 to the inflection point IP at time T9 between the accelerating rising hydrocarbon production rate R10 and the decelerating rising hydrocarbon production rate R11.

Such as detailed in FIG. 6A and FIG. 6B, in further configurations, initial delivery of the seventh enhancing fluid injection F7 at time TE8 may begin during the accelerating rate of the increasing hydrocarbon production rate R10 before reaching the inflection point IP. e.g., during the period of acceleration in the rising hydrocarbon production rate R10, before the accelerating rise changes to a decelerating rise at the inflection point IP at time T9 leading to decelerating rising hydrocarbon production rate R11. In a further configuration, initial delivery of enhancing fluid at TE8 may occur at or shortly after the start of operation at T0. Such early commencement of seventh enhancing fluid injection F7 may begin at time TE8 before the start of hydrocarbon production at the beginning of accelerating hydrocarbon production rate R10.

In some configurations, further eighth enhancing fluid injection F8 may be delivered from time TE9 at a rising rate from the fourth fluid enhancement injection rate FE4 to a fifth fluid enhancement injection rate FE5 at time TE10. Enhancing fluid delivery may then continue at the fifth enhancement fluid injection rate FE5 as ninth enhancing fluid injection F9, One or more of such enhancing fluid delivery F8 and F9 may then cause an increasing hydrocarbon production rate R13 past a second inflection point IP2 to the high CO2 enhanced primary production peak PP6 at time T15.

In some configurations, the enhancing fluid may be delivered during rising hydrocarbon production rates R10, R11 and R13 where the enhancing fluid injections F7 and F8 are delivered within a prescribed range of the highest increasing design injection, as constrained by a hydrocarbon reservoir porosity and a hydrocarbon pore fluid displacement rate subject to a maximum allowable reservoir pressure within production safety limits. e.g., design rates for enhancing fluid injections F7 and F8 may be selected to be between 100% and 67%, 80%, 85%, 90% or 95% of the design safety limit.

Referring further to FIG. 6A, in some embodiments, the initial delivery rate of enhancing fluid injection F7 per injection well may be limited not just by the maximum safe delivery pressure, but by composition of the hydrocarbon pore space. The allowable delivery rates of enhancing fluid injections F7 and F8 may increase with increasing production. In some configurations, the calciner production is raised at an allowed design temperature rise rate to a design alkali production rate of alkaline oxide. The delivery rate constraints are then met by adjusting the number of enhancing fluid injection wells to safely deliver the enhancing fluid as a function of the production history.

Such methods may beneficially utilize the maximum enhancing fluid available while providing faster CO2 enhancement of hydrocarbon resources being enhanced in one or more trial sites than is achieved by conventional practice. In other configurations, the calciner lime production rate and thus CO2 generation rate may be controlled at a rising rate up to the design alkali oxide production rate to account for such transient delivery limitations with a fixed set of enhancing fluid injection wells 624.

Referring to FIG. 6A with FIG. 6B detail, such early enhancement may avoid primary hydrocarbon production rate R12 declining after a fifth or low CO2 primary production peak PP5 at time T10. This may result in more rapidly rising hydrocarbon production rates R10 and R11 to more rapidly reach the production level equal to the fifth or low CO2 primary production peak PP5 at an earlier time. In some configurations, the sixth or high CO2 enhanced primary production peak PP6 may be greater than 250%, 300%, 400%, or 500% of the inflection production rate P1 at the inflection point IP between accelerating rising hydrocarbon production rate R10 and decelerating rising hydrocarbon production rate R11. Such an unexpected improvement by change from conventional practice would beneficially increase the ROI.

As further detailed in FIG. 6A and FIG. 6B, one or more additional calciners may be used to generate and deliver further enhancing fluid at a rising tenth enhancing fluid injection F10 from the fifth fluid enhancement injection rate FE5 at enhancing time TE11 to enhancing time TE12. This may be followed by rising enhancing fluid delivery up to a maximum eleventh enhancing fluid injection F11 at a sixth fluid enhancement injection rate FE6 from enhancing times TE12 to TE13. e.g., for those calciners to accommodate higher allowable delivery of enhancing fluid with progressive production. Such eleventh enhancing fluid injection F11 may then be reduced from the sixth fluid enhancement injection rate FE6 at enhancing time TE13 along a declining twelfth enhancing fluid injection F12 to shutdown of enhancing fluid delivery at enhancement time TE14.

One or more of such enhancing fluid injection F10, F11, and F12, may reverse the declining hydrocarbon production rate R14 at time T16 after the CO2 enhanced primary production peak PP6, resulting in a rising hydrocarbon production rate R15 to a seventh or extended CO2 primary production peak PP7 at time T17, with a subsequent declining hydrocarbon production rate R16 to operation shutdown at time S6. Such enhancing fluid F10, F11 and F12 may provide an additional volume V7 of enhanced production between the declining hydrocarbon production rate R14 extrapolated to shutdown S5 and the rising hydrocarbon production rate R15 to the seventh or extended CO2 primary production peak PP7 followed by the falling hydrocarbon production rate R16 to shutdown at time S6. Such new CO2 may further be combined with one or more extended or additional vertical and/or horizontal injection wells and/or production wells that facilitate such increased production.

Referring to FIG. 1, FIG. 2, and FIG. 3, available calcining capacity may be used to change delivery from one pilot and/or production site to another as production progresses. For example enhancing fluid delivery may be changed from the first hydrocarbon trial site HT1 to one or more of the first hydrocarbon production site HP1 in the first hydrocarbon resource H1, the second hydrocarbon trial site HT2, and the second hydrocarbon production site HP2 in the second hydrocarbon resource H2, such as shown in FIG. 1.

Referring to FIG. 1, FIG. 2, and FIG. 3, initial generation of about 554 metric ton CO2/day in some configurations may deliver about 61 metric ton of new CO2 per injection well per day into 9 enhancing injection wells 624. These may be configured in an inverted five spot pattern feeding 16 production wells 574 per 2.59 sq km (one square mile) at a spatial density of 16 ha/well (40 acres/well). e.g., feeding 34 metric ton of new CO2/production well/day. In a typical field this may provide over time an average of about 20 metric ton/day (150 bbl/day) of hydrocarbon (e.g. a light oil) per production well. I.e., about 332 metric ton/day (2,400 bbl/day) of hydrocarbon production, under some conditions producing an average of 0.6 metric ton hydrocarbon/metric ton net new CO2 delivered. Such rates and ratios may vary with the hydrocarbon resource, enhancing fluid(s) and production time.

The CO2 generated may similarly be injected into fewer or more enhancing injection wells 624 according to the capacity of the local hydrocarbon resource to accept CO2. For example, about 17 metric ton/day of CO2 may be injected into each of 18 enhancing injection wells 624. Similarly, about 8.5 metric ton/day of CO2 may be injected into each of 36 enhancing injection wells 624 for the corresponding 16 production wells. As injected CO2 is recovered and recycled, such generation and delivery of new CO2 plus recycled CO2 may feed a larger number of enhancing injection wells. For example, with a 67% recycle rate, such generation of CO2 would nominally feed 27 injection wells at about a 61 metric ton/day average, sufficient for about 48 production wells at about 34 metric ton CO2/day per production well on average. The actual hydrocarbon production profile is expected to rise rapidly to an enhanced production peak above the average enhanced production, and then to decline over time with hydrocarbon production. Such injection and production rates are but indicative, and may be expected to vary or be scaled from field to field according to the local hydrocarbon and geological properties and distributions, and the enhancement and production strategy.

Controlling the rate of injecting CO2: With reference to FIG. 5, FIG. 6A, and FIG. 6B, in some configurations, the rate of injecting enhancing fluid comprising CO2 may be adjusted to an enhancing fluid injection rate that provides rapid response while constraining the subsurface pressure to below a safe design operating pressure. For example, the enhancing fluid injection rate may be selected to maintain the pressure within 50%, 70% or 90% of the design safe operating pressure for the resource at that prescribed depth. For example, the design safe operating pressure may be set at the hydrostatic fracture pressure less a prescribed safety margin.

In further configurations, the CO2 injection rate may be configured to provide a prescribed ramp of an increased hydrocarbon production rate to obtain the maximum hydrocarbon production response within one of 24 months, 18 months, 15 months, 12 months, 9 months, or 6 months, while maintaining fluid pressure within a prescribed range below the safe design operating pressure or geophysical pressure limits. i.e., higher injection rates per well may be used to initially deliver CO2 to provide a higher maximum pressure, a higher hydrocarbon pore volume fill, a higher hydrocarbon production rate, and a shorter time to maximum hydrocarbon enhancement response than historical CO2 injection practice. Such faster and/or higher enhancement fluid injection than conventional operation may may be expected to beneficially cause earlier and/or higher production, increasing the Return On Investment (ROI).

Controlling the amount CO2 delivery: Referring to FIG. 2 to FIG. 6B, in some configurations, the CO2 injection or delivery rate profile and duration may be configured or controlled to fill a prescribed portion of the hydrocarbon pore volume (HCPV) in the resource or reservoir greater than historical amounts of less than 0.5 HCPV. For example, configurations may variously elect to deliver enhancing fluid to amounts of one or more of 1.0 HCPV, 1.5 HCPV, 2.0 HCPV, 2.5 HCPV or 3.0 HCPV over time. In some applications, the CO2 delivery rate profile of delivering enhancing fluid or CO2 may be configured to deliver CO2 at a prescribed HCPV fraction per year. For example, some configurations may inject CO2 at a rate of one or more of 0.02, 0.05, 0.1, 0.2, 0.3, or 0.4 HCPV/year, within the limits of field porosity and the maximum safe delivery pressure.

In some configurations, enhancing fluid may be delivered into the injection wells at the rate of recovering enhancing fluid plus generating enhancing fluid with at least 85% of the enhancing fluid generating design capacity of one or more calciners utilized, and configuring the number of injection wells to maintain the enhancing fluid delivery pressure between 75% and 100% of a prescribed safe delivery pressure.

Referring to FIG. 2 and FIG. 3, in some oil enhancing configurations, the number of injection wells to which enhancing fluid is delivered within the first enhancement site may be adjusted in proportion to the rate of carbon dioxide being generated plus the carbon dioxide being recycled, to deliver carbon dioxide at a delivery rate greater than a 0.1 hydrocarbon pore volume HCPV per year of hydrocarbon resource served by a plurality of production wells surrounding the injection wells.

In further configurations, enhancing fluid may be delivered into the first enhancement site at a rate of more than 0.2 HCPV/year of the hydrocarbon resource served by the plurality of enhancing injection wells delivering enhancing fluid.

CO2 alternating Water (CAW): The CO2 enhanced primary production portrayed schematically in FIG. 6A and FIG. 6B may be further enhanced by delivering one or more of aqueous fluid, and CO2 alternating aqueous fluid (herein CO2 alternating Water or “CAW”). Similar configurations may use a Gas Alternating Water (GAW) strategy by delivering other gases such as one or more of nitrogen and gaseous hydrocarbons such as methane, ethane and propane. Such hybrid fluid delivery to increase hydrocarbon production may include delivering a plurality of fluids comprising one or more of CO2 from one or more calciners, water, thickeners, viscosity enhancers, and foams.

Such CAW and/or GAW combinations may be delivered during primary production of one of the hydrocarbon resources. e.g., some configurations may deliver with enhancing fluid alternating aqueous fluid (CAW) after the sixth or high CO2 enhanced production peak PP6 at time T15. Other configurations may deliver CO2 alternating Water (CAW) after the seventh or extended CO2 primary production peak PP7 at time T17. Further configurations may deliver CO2 alternating aqueous fluid after one of the second inflection point IP2 and the fifth or low CO2 primary production peak PP5. Some configurations may delivery CO2 alternating aqueous fluid before reaching one of the first inflection point IP at time T9, twice the time T9 of the inflection point IP, declining to 75% of the CO2 primary peak PP5, at time T13, or declining to 50% of the primary peak PP5 at time T14.

In further configurations, the enhancing fluid may be delivered alternating with one of water and/or aqueous fluid into a mature oil field after the the beginning of secondary production at time T4 or secondary production peak PP3 at time T5 such as shown in FIG. 5. The plurality of enhancing fluids may be delivered to one or more of a primary oil field, a mature oil field, a “brownfield” Residual Oil Zone (“brownfield ROZ”) below a primary or mature oil field. Such hybrid plurality of enhancing fluid may increase production leading to an hybrid CO2 enhanced production such as an eighth peak (not shown) after the seventh or extended CO2 primary production PP7 depicted in FIG. 6A. Similarly, such hybrid CO2 enhanced production may result in the eighth peak being higher or broader than the seventh or extended CO2 primary production peak PP7. In some configurations, such hybrid enhancing fluids may be applied to recovering hydrocarbons from a naturally water swept “greenfield” Residual Oil Zone (“greenfield ROZ”) adjacent to and/or separate from a conventional primary and/or mature oil fields.

Forming calcined CO2 enhancing fluid: The enhancing fluid comprising CO2 generated by calcining may be formed using one or more CO2 separation methods known or proposed in the art summarized below. The co-filed invention describes a calcining method comprising indirect heating comprising heat recuperation and/or heat regeneration, such as using a high temperature refractory ceramic or metal heat exchanger. With heat recovery, this method enables converting a vertical calcining kiln to provide efficient recovery of the CO2 generated without requiring absorption/-desorption or membranes.

Oxy-fuel combustion: In some embodiments, an oxidant fluid comprising oxygen or oxygen enriched air may be used to combust fuel to form a high CO2 combustion gas with reduced or low nitrogen content. This may be used to form one of enhancing fluid F62 and blocking fluid F794 with little oxygen. e.g., oxygen enriched air may have one of 50%, 80%, 90%, 95% or 98% oxygen.

Absorption CO2 scrubbing: In some configurations, an absorptive liquid may be used to absorb CO2 generated by calcining the alkaline carbonate. The absorbed CO2 may then be recovered to deliver concentrated CO2. For example, CO2 may be recovered by heating the CO2 containing liquid or by reducing its pressure. In some configurations, the absorptive liquid may comprise one of an amine such as monoethanolamine (MEA) or piperazine, an alcohol such as methanol (e.g., the “Rectisol®” process), an ether such as dimethyl ether of polyethylenene glycol (e.g., Selexol®), an organic carbonate such as dimethyl carbonate (DMC), ionic solvents such as alkyl or N-functionalized imidazoles (e.g., from ION Engineering LLC), an inorganic carbonate such as potassium carbonate, liquid ammonia, or mixtures thereof.

Adsorption CO2 capture: In embodiments configurations, an adsorptive solid may be used to adsorb CO2 generated by calcining The adsorbed CO2 may then be released to deliver concentrated CO2, such as by heating the material and/or by reducing its pressure. For example, the adsorptive solid may comprise a natural zeolite, a synthetic molecular sieve, an activated carbon, a metal organic framework (MOF), and/or a structured adsorbent such as VeloxoTherm™ from Inventys. Calcium looping may be used using one or more of finely ground calcium oxide (quicklime), magnesium oxide, and dololime operating in a carbonation pressure and temperature regime. Chemical looping using other metal oxides such as iron oxide, and copper oxide, may similarly be used. Steam heating may be used to calcine the carbonate and/or improve calcining reactivity.

Direct contact solids heating: Direct contact heat exchange between combustion and alkaline carbonate comprising heated solid particles may be used in some configurations. For example, a fluidized bed combustor may be used to heat a particulate heat transfer media such as an alkaline oxide comprising one of lime, dololime, and magnesium oxide, to greater than a carbonate calcining temperature. A portion of the heated particulate media may be delivered to a second fluidized bed fed with comminuted alkaline carbonate. In the second fluidized bed, the heated particulate media heats and calcines the alkaline carbonate.

A recycling portion of the particulate media such as alkaline oxide from the second fluidized bed may be returned to the first fluidized bed to be reheated while a product portion of the alkaline oxide may be withdrawn from the second fluidized bed and may be delivered to one or more markets. The carbon dioxide generated by calcining in the second fluidized bed may be separated from particulate media, alkaline oxide, and residual carbonate and may be withdrawn from the second fluidized bed for use in enhancing fluid. Heat may be recovered from one or both of the generated carbon dioxide and the product alkaline oxide to preheat one or more of fuel, oxidant, diluent and/or heat transfer media used in the first fluidized bed.

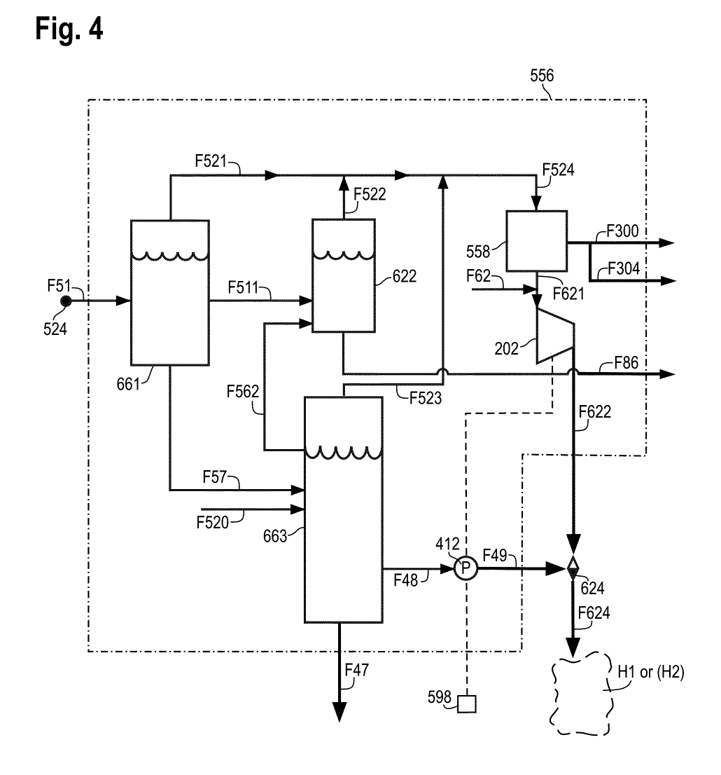

CO2 Separation & recycling: Referring to FIG. 4, in some embodiments the produced fluid F51, comprising hydrocarbon and one of CO2 and water, may be produced from one or more production wells 524 and processed through the first fluid separation battery 556 to separate produced fluid F51 into a hydrocarbon fluid F86, enhancing fluid F622 comprising CO2, and an aqueous injection fluid F49. A portion of aqueous fluid F49 may be delivered to hydrocarbon resource H1 and/or (H2). Produced fluid F51 may be separated in a primary separator 661 into a gaseous stream F521 comprising CO2, an intermediate hydrocarbon stream F511 comprising a hydrocarbon, and a denser aqueous stream F57 comprising water. The primary separator 661 may comprise one or more produced fluid storage tanks.

The intermediate hydrocarbon fraction or stream F511 may be stored in an hydrocarbon storage tank 622. A portion of the gaseous stream F521 may be compressed by a compressor 202 and delivered as a portion of enhancing fluid F622 through one or more injection wells 624 back to one or both of the hydrocarbon resources H1 and/or (H2). Aqueous fluid F57 may be stored in an aqueous storage tank 663. Aqueous fluid F48 may be drawn from the aqueous storage tank 663 and pressurized by a pump 412 to inject pressurized aqueous fluid F49 into the hydrocarbon resource or reservoir via one or more injection wells 624. For example, pressurized aqueous fluid F49 may be used as a prescribed ‘water flood’ interspersing enhancing fluid floods, such as “water alternating gas” (WAG). A residual fluid comprising solids F47 may be withdrawn from the aqueous storage tank 663 and suitably disposed of.

In some configurations, the primary separated fluid streams may be further processed by secondary separation in the first fluid separation battery 556. For example, the aqueous stream F57 may be further processed using a skimmer 663 to skim off a residual hydrocarbon stream F562 and deliver it to the hydrocarbon storage tank 622. Hydrocarbon fluid F86 may then be transported from hydrocarbon storage tank 622 to market. e.g., crude oil or heavy oil etc. A gaseous fluid F522 comprising one of CO2 and a gaseous hydrocarbon may be stripped from the hydrocarbon fluid F511 in the hydrocarbon storage tank 622 and combined with the recovered gaseous stream F521. This combined gaseous fluid F524 may then be compressed by the compressor 202 and the resultant enhancing fluid F622 reinjected into one or more injection wells 624.

Referring further to FIG. 4, in some embodiments, the first fluid separation battery 556 may be configured with a CO2 separation system 558 to recover enhancing fluid comprising fluid CO2 F621 from the gaseous fluid stream F524 and deliver a first gaseous portion F300 comprising a gaseous hydrocarbon from the first fluid separation battery 556. A second gaseous portion F304 comprising gaseous hydrocarbon may be delivered as a fuel fluid to one of calciners C1, C2, C3 and/or C4 such as are symbolized in FIG. 1. New or makeup enhancing fluid F62 comprising CO2 may be added to recovered CO2 F621 to be compressed by compressor 202 in delivering enhancing fluid F622 to enhancing injection wells 624 to deliver as enhancing fluid F624 into one or more hydrocarbon resources H1 and (H2).

In some configurations, the gaseous fluid F524 may be used directly as fuel in one or more of calciners C1 through C4. For example, in some situations, rather than flaring it, gaseous fluid F524, F300 and/or F304 may be combusted to form lime and generate CO2 that can then be used as enhancing fluid for further producing fluid F51 comprising hydrocarbons from one or more resources H1 or H2. In other configurations, a gaseous hydrocarbon fluid may be obtained by fracking for use in calcining carbonate to form enhancing fluid comprising CO2 to recover a produced fluid F51 comprising liquid hydrocarbon.

Alkaline oxide stores: As further depicted in FIG. 1 alkaline oxide stores 885 to buffer alkaline oxide production may be provided, usually located near one or more of calciners C1, C2, C3 and C4. Alkaline oxide stores 885 may comprise enclosed or covered piles for coarse alkaline oxide, and/or silos, such as for ground or pulverized alkaline oxide or cement.

Material transporters: One or more material transporters (not shown) may be provided from one or more rail, road or water transport means to one or more fuel stores 881, carbonate stores 883, and/or alkaline oxide stores 885. e.g., belt conveyors, drag conveyors, and/or pneumatic ducts. One or more material transporters (not shown) may be provided to transport fuel and/or carbonate from fuel stores 881 and/or carbonate stores 883 to one or more calciners C1, C2, C3 and C4. One or more material transporters may further be provided to transport alkaline oxide from calciners to alkaline stores 885 and/or thence to said rail, road or water transport means.

Relocatable: In further configurations, a portion of fuel stores 881, carbonate stores 883 and/or alkaline oxide stores 885 may be configured as relocatable stores. e.g., as movable silos transportable such as on self propelled multiaxle motorized wheel modular transporters and/or rail wagons. One or more calciners C1, C2, C3 and C4, may be configured to be similarly relocatable. One or more material transporters between one or more of said transport means, fuel stores 881, carbonate stores 883, calciners C1, C2, C3 and C4, and/or alkaline oxide stores 885, may be configured to be dismountable and relocatable. e.g. conveyors or pneumatic ducts.

Extending highways: Referring to FIG. 1, in some embodiments, existing transport routes may be extended or upgraded to handle the new transport requirements. For example, an extension highway HH1 may be built from quarry Q1 to calciner C1 or further to highway HH2. Similarly an existing road HH1 may be upgraded to handle the heavier transport loads of hydrocarbon, limestone, or lime etc. With the expansion from Calciner C2 to calciner C2, highway HW1 may be extended from near quarry Q1 to near quarry Q2. With the relocation of calciner C1, highway HW1 may be extended to calciner C3 near the first hydrocarbon trial site HT1 in resource H2.

Extending railroads: In some configurations the first railroad or rail spur RR1 may be built, extended, or upgraded from the second railroad RR2 to the first calciner C1. With increased production and installment of calciners C2 and then C3, first rail spur RR1 may be extended to calciner C2 and to calciner C3. For example, first rail spur RR1 may be extended to calciners C2 and C3 after operation of calciner C1 proves enhancement in the first hydrocarbon trial site HT1. First rail spur RR1 may initially be configured to accommodate unit trains of 25 to 75 rail cars, such as 50 cars. Provision may be made to expand first rail spur RR1 to handle unit trains of 75 to 150 rail cars, such as 100 to 120 rail cars. Similarly, the expansion calciner C4 may be configured near quarry Q2 with rail spur RR4 extended from first rail spur RR1 to accommodate unit trains from 75 to 150 rail cars.

Providing pipelines: Referring to FIG. 1, in some embodiments, enhancing fluid pipelines are provided from one or more calciners to the plurality of enhancing injection wells distributed across the hydrocarbon resource to inject enhancing fluid. Production pipelines may be provided to transport the produced fluid to one or more primary separators 661 such as production fluid storage tanks Water pipelines may be provided to deliver aqueous fluid as needed alongside enhancing fluid pipelines. For example, pipeline PL1 for enhancing fluid with associated water pipelines (not shown) may be provided from calciner C1 to the first hydrocarbon trial site HT1.

Relocating calciners: Referring to FIG. 1, some embodiments provide for relocating a calciner from near the population center to near a hydrocarbon resource near a carbonate resource. For example, the first calciner C1 may be relocated from by the first quarry Q1 in the first carbonate resource L1 near the first hydrocarbon trial site HT1 in the first hydrocarbon resource H1, to near the second hydrocarbon trial site HT2 in the second hydrocarbon region H2 near the first railroad RR1 that runs close to or by one or both of the first quarry Q1 and/or the second quarry Q2 in the first carbonate resource L1.

Similarly, the fifth calciner C5 may be relocated from a second limestone, dolomite or carbonate resource L2 near the first population center PC1 and/or the industrial center IU1, such as close by railroad RR3 and/or highway HW3, to near or on the second hydrocarbon trial site HT2 of the second hydrocarbon resource H2. This relocated or now third calciner C3 may be located close to the first railroad RR1 and/or the first highway HW1 and near the first carbonate resource L1.

Per FIG. 1, in some embodiments, the remote fifth calciner C5 may be relocated from an existing production site by a third quarry Q3 on a second carbonate resource L2 near the first population center PC1 and/or the industrial user IU1, to provide the first calciner C1 near the first quarry Q1 on the first carbonate resource L1, and/or the third calciner C3 on or near the second hydrocarbon trial site HT2 within the analogous or second hydrocarbon resource H2. In some configurations, the first calciner C1 may be relocated from near the first quarry Q1 near the first hydrocarbon trial site HT1, to third calciner location C3 near the second hydrocarbon trial site HT2 within the second hydrocarbon resource H2.

The first calciner C1 may be relocated after proving hydrocarbon enhancement in the first hydrocarbon trial site HT1 with the first enhancing fluid, to similarly prove hydrocarbon enhancement at the second hydrocarbon trial site HT2 within the second hydrocarbon resource H2. Such CO2 enhanced production may provide the basis for evaluating CO2-EOR contingent resources per industry standards.

The enhanced hydrocarbon production from one or both the first hydrocarbon trial and hydrocarbon production sites HT1 and HP1 in hydrocarbon resource H1 may be used as analogous information to quantify hydrocarbon reserves or CO2-EOR “Contingent Resources” in the second hydrocarbon trial site HT2 and/or the second hydrocarbon production site HP2 in hydrocarbon resource H2 such as per industry guidelines.

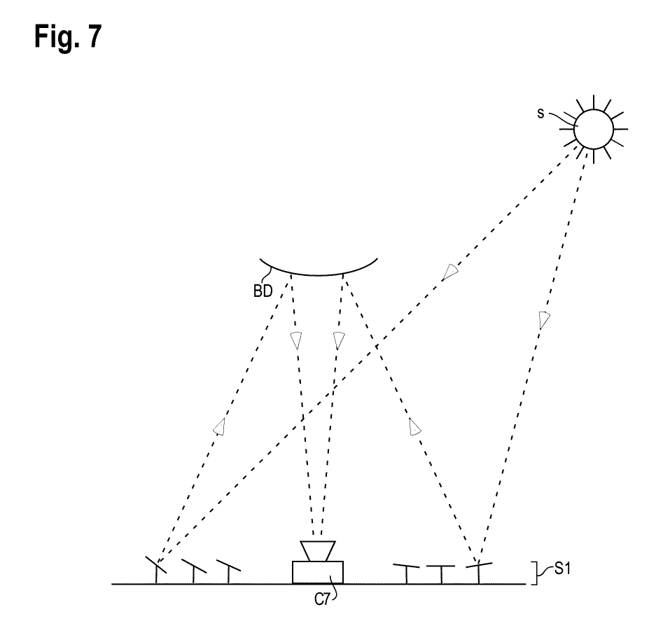

1^{st} Solar Calciner EOR: Referring further to schematic FIG. 1 and FIG. 7, in some embodiments of the Calciner Enhanced Oil Recovery™ system 10, a first solar array S1 of heliostats or concentrators may be configured to direct and focus sunlight from the sun S into a solar seventh calciner or kiln C7 located near, adjacent to or within the first solar array S1. e.g., such as by a beam down reflector BD or solar receiver (not shown). The first solar array S1 and/or the solar seventh calciner C7 may be located near, close to or on or over one of the first carbonate resource L1, the first hydrocarbon trial site HT1 on the first fossil or hydrocarbon resource H1, and/or the second hydrocarbon trial site HT2 on the second fossil or hydrocarbon resource H2.

A transport means such as fifth railroad RR5 may be extended to near, close to, or by the first solar array S1 and connected to one of the first railroad RR1 and the second railroad RR2, or to a similar highway (not shown, such as connected to the first highway HW1 or the second highway HW2) traversing or near the first carbonate resource L1. Alkaline carbonate from the first carbonate resource L1 may be mined or extracted and comminuted or crushed in one or more of the first mining-crushing system MC1 and the second mining-crushing system MC2. Crushed carbonate formed thereby may be transported by transport means such as the fifth railroad RR5 (or similar highway) from the first or second mining-crushing system MC1 or MC2 and delivered to carbonate store 883 by or adjacent the solar seventh calciner C7 to buffer crushed carbonate supply.

Crushed carbonate comprising calcium (calcite or limestone), magnesium (magnesite), or a mixture thereof (e.g. dolomite), may be heated or calcined in the seventh solar calciner C7 sufficiently to generate CO2 and an alkaline oxide comprising calcium oxide (lime), magnesium oxide (magnesia), or a mixture thereof (dololime). Carbon dioxide produced by calcining crushed carbonate in the solar seventh calciner C7 may be delivered via one or more pipelines to one or more of the first hydrocarbon field H1 and the second hydrocarbon field H2. e.g., the CO2 may be delivered by a pipeline PL7 connected to one or more pipelines PL1, PL2, PL3, PL4 and PL5. Calcined calcium oxide (lime) produced by the solar seventh calciner C7 may be transported to one or more remote demand sites such as one or more of the first industrial user IU1, the second industrial user 1U2, the first population P1, with the first population center PC1, and/or the second population P2 with the second population center PC2. The produced calcium oxide (lime) may be stored in buffer alkaline oxide stores 885 near or by one or both of the solar seventh calciner C7 and the railroad RR5 to buffer alkaline oxide production. In some configurations, fuel stores 881 may be provided near the solar seventh calciner C7 to complement the solar resource. e.g., to hold compressed or liquid natural gas, biomass and/or coal.

2^{nd} Solar Calciner EOR: Referring further to schematic FIG. 1 and FIG. 7, in some embodiments of the Calciner Enhanced Oil Recovery system 10, a second solar array S2 of heliostats or concentrators may be configured to direct and focus sunlight from the sun S into a solar eighth calciner or kiln C8 located near, adjacent to or within the second solar array S2. e.g., such as by a beam down reflector BD or solar receiver (not shown). The second solar array S2 and/or the solar eighth calciner C8 may be located near, close to or on or over one of the first carbonate resource L1, the second hydrocarbon trial site HT2 on the second fossil or hydrocarbon resource H2 (and/or the first hydrocarbon trial site HT1 on the first fossil or hydrocarbon resource H1.)

A transport means such as sixth railroad RR6 may be extended to near, close to, or by the second solar array S2 and connected to one of the first railroad RR1 and the second railroad RR2, or to a similar highway (not shown, such as connected to the first highway HW1 or the second highway HW2) traversing or near the first carbonate resource L1. Alkaline carbonate from the first carbonate resource L1 may be mined or extracted and comminuted or crushed in one or more of the first mining-crushing system MC1 and the second mining-crushing system MC2. Crushed carbonate formed thereby may be transported by transport means such as the sixth railroad RR6 (or similar highway) from the first or second mining-crushing system MC1 or MC2 and delivered to carbonate store 883 by or adjacent the solar eighth calciner C8 to buffer crushed carbonate supply.

Crushed carbonate comprising calcium (calcite or limestone), magnesium (magnesite), or a mixture thereof (e.g. dolomite), may be heated or calcined in the solar eighth calciner C8 sufficiently to generate CO2 and an alkaline oxide comprising calcium oxide (lime), magnesium oxide (magnesia), or a mixture thereof (dololime). Carbon dioxide produced by calcining crushed carbonate in the solar eighth calciner C8 may be delivered via one or more pipelines to one or more of the second hydrocarbon field H2 and the first hydrocarbon field H1. e.g., the CO2 may be delivered by a pipeline PL8 connected to one or more pipelines PL4, PL2, PL3, and PL5.

Calcined calcium oxide (lime) produced by the solar eighth calciner C8 may be transported to one or more remote demand sites such as one or more of the first industrial user IU1, the second industrial user IU2, the first population P1, with the first population center PC1, and/or the second population P2 with the second population center PC2. The produced calcium oxide (lime) may be stored in buffer alkaline oxide stores 885 near or by one or both of the solar eighth calciner C8 and the railroad RR6 to buffer alkaline oxide production. In some configurations, fuel stores 881 may be provided near the solar eighth calciner C8 to complement the solar resource. e.g., to hold coal, compressed or liquid natural gas and/or biomass.

Relative positioning: Referring further to FIG. 1, in some embodiments, a first local solar trial CO2 delivery distance, to the center of the first hydrocarbon trial site HT1, having an enhancing injection well weighted first enhancement location, from the local solar seventh calciner C7 at the solar seventh calcining site, may be less than 67% of a first remote CO2 delivery distance, to the first enhancement or hydrocarbon trial site HT1 from the remote fifth calciner C5 at a remote calcining site, having an equal or greater remote CO2 generating capacity than the local solar CO2 generating capacity of the local solar seventh calciner C7. In other configurations, the first local solar trial CO2 delivery distance to the first hydrocarbon trial site HT1 may be less than 50% of the first remote CO2 delivery distance from the remote fifth calciner C5.

In some embodiments, a first local solar production CO2 delivery distance, to a center of the first hydrocarbon production site HP1 from the solar eighth calciner C8 at an solar eighth calcining site, may be less than 50% of a second remote CO2 delivery distance, to the center of first hydrocarbon production site HP1 from the location of a large remote sixth calciner C6 at a remote calcining site, wherein the large remote sixth calciner C6 has an equal or greater remote CO2 generating capacity than the local CO2 generating capacity of the local solar eighth calciner C8.

In some embodiments, a local mean solar CO2 delivery distance, to a first hydrocarbon center HC1 of the first hydrocarbon resource H1, weighted by an oil in place, from the mean of locations of the solar seventh calciner C7 location and the solar eighth calciner C8, may be less than 40% of a remote mean CO2 delivery distance to the first hydrocarbon center HC1 of hydrocarbon resource H1 from the mean of the location of the nearest remote or fifth calciner C5 and the location of the next nearest or sixth calciner C6, together having an equal or greater CO2 generating capacity than the combined capacity of the solar seventh calciner C7 and the solar eighth calciner C8. In other configurations the local mean solar CO2 delivery distance may be less than 33% of the remote mean CO2 delivery distance.

Referring further to FIG. 1, in some configurations, a first local solar CO2 delivery distance to the first resource weighted hydrocarbon center HC1 of the first hydrocarbon resource H1 from the solar eighth calciner C8 may be less than a prescribed solar CO2 delivery distance. For example, the prescribed solar CO2 delivery distance may be less than 65% of a remote alkali demand distance for alkaline oxide DADP, from the first hydrocarbon center HC1 to a demand weighted alkali demand center ADP of the first remote population region P1 and the second remote population region P2.

In another configuration, a second local solar CO2 delivery distance from the site of the second calciner C8 to the first enhancing injection well weighted enhancement location may be less than 60% of a scalar average alkali demand distance (DADC), of an average of one or more absolute scalar distances from the enhancing injection well weighted enhancement location H1 to a combined alkali demand (ADC) of one or more alkali demands selected from one or more population demand centers, and one or more industrial demand center, having the combined alkali demand for alkaline oxide greater than a design alkali generation rate of alkaline oxide generation achievable by calcining carbonate in solar eighth calciner C8.

In a further configuration, per FIG. 1, the plurality of calciners at calcining sites may be operable to generate enhancing fluid for injection and mobilizing hydrocarbon at a plurality of hydrocarbon enhancement sites, wherein the production well weighted production distance, to the first mean enhancement center of the plurality of hydrocarbon enhancement sites, from a mean calcining center CCT of the plurality of calcining sites near the first hydrocarbon resource, is less than 50% of the average alkali demand distance, of the demand weighted absolute scalar distances to the first mean enhancement center from the plurality of population and/or industrial alkaline oxide demand locations having collectively am equal or greater alkaline demand than the plurality of calcining sites.

In some configurations, a mean solar CO2 enhancing fluid delivery distance for enhancing fluid comprising CO2 to the first resource weighted hydrocarbon center HC1 of first hydrocarbon resource H1 from a production weighted solar calcining center SCCT of a plurality of a nearby operating calciners, comprising a solar calciner with one or more calciners and/or solar calciners, having a combined design alkali generating capacity to produce alkaline oxide, may be less than 50% of a remote mean demand distance CM of an alkali demand weighted average of absolute scalar distances from the first hydrocarbon center HC1 to an alkali demand weighted market CM of a plurality of one or more of the first population center PC1, the second population center PC2, and the first industrial user IU1 and the second industrial user IU2, having a alkali demand greater than the combined design alkali generating capacity of the plurality of nearby operating calciners. For example, the production weighted solar calcining center SCCT may be the production weighted location of the plurality of nearby operating calciners comprising two or more of the solar seventh calciner C7, the solar eighth calciner C8, the first calciner C1, the second calciner C2 and the third calciner C3, and the fourth calciner C4, as they are put into production.

In some configurations, per FIG. 1, a mean alkali demand distance, of the scalar average absolute distances from an area weighted mean enhancement location HE1, of the first hydrocarbon trial site HT1 and the first hydrocarbon production site HP1, to one or more remote alkali demands for alkaline oxide, comprising one or more of population centers and one or more industrial users, may be greater than a production distance, to the first mean enhancement location HE1 from the first mean supply location CS1 of the carbonate supply sites quarry Q1 and quarry Q2, wherein the remote alkali demand is greater than the combined local solar calciner design alkali oxide production capacity of the plurality of nearby operating calciners. For example, nearby operating calcining sites may include two or more of the solar seventh calciner C7, the solar eighth calciner C8, the first calciner C1, the second calciner C2, the third calciner C3, and the fourth calciner C4, as they are put into production and produce alkaline oxide comprising calcium or magnesium.

In some configurations a carbonate of calcium and/or magnesium may be mined at one or more of the first mining site or quarry Q1 and/or the second mining site or quarry Q2 in the first carbonate resource L1, at a mining distance less than a prescribed solar mining distance from the first hydrocarbon enhancement site HT1 in a first hydrocarbon resource H1. In some configurations, the prescribed solar mining distance may be less than one of 40%, 50% or 60% of a remote calcining distance to one of remote calciners C5 and/or C6 having an equal or greater design calcining capacity than a solar design calcining capacity of the respective solar seventh calciner C7, or solar eighth calciner C8, or a combination of such local solar calciners.

In further configurations, one or more of the solar calcining methods described herein may be combined with or performed like one or more non-solar calcining methods as schematically depicted in FIG. 1 through FIG. 6 and described herein.

Calcine in situ: Referring further to FIG. 1, in some embodiments, gaseous fuel may be combusted in situ in carbonate resource L1 with oxidant fuel to calcine carbonate to generate CO2. The resulting combustion fluid comprising CO2 may be delivered to one of hydrocarbon resources H1 and H2 to enhance hydrocarbon recovery. Such combustion may be enhanced by fracking the carbonate resource to enhance one of heat transfer into the carbonate and CO2 recovery from the carbonate.

In some configurations, such in situ calcining may be combined with fracking one of hydrocarbon resources to enhance hydrocarbon production. For example, fracking tight oil reservoirs may release substantial gaseous hydrocarbon that may be combusted in situ to generate CO2 by calcining carbonate rather than flaring it. In other configurations, one hydrocarbon resource may be fracked to produce a gaseous hydrocarbon that may be used to calcine carbonate to generate CO2 which in turn may be used to enhance hydrocarbon production for liquid hydrocarbon.

Hybrid Calciner EOR: Referring further to FIGS. 1 to 3, in some embodiments, the Calciner Enhanced Oil Recovery (CEOR) methods described herein for production level CO2-EOR may be combined with relevant art CO2 capture and delivery. Relatively small volume CO2 may be sourced from relevant art CO2 sources for trial CO2-EOR sufficient to prove and “book” a CO2-EOR resource. e.g., such as for one to three years. Such enhancing fluid F624 comprising CO2 may be supplied and/or captured from an existing natural and/or anthroprogenic source such as described herein. Such trial enhancing fluid F624 may then be delivered to one or more of the first trial site HT1 and the second trial site HT2 sufficient to prove the CO2 enhanceable resource at those trial sites.

In some configurations, such trial enhancing fluid F624 may be transported to site from a conventional industrial CO2 supply, such as an air separation plant. The CO2 source may be relocated to near one of trial sites HT1 and/or HT2 such as generating and capturing CO2 from exhaust gas on site with a field deployable power generation and CO2 capture system. In further configurations, sufficient CO2 for trial enhancing fluid F624 may be captured from a local or relatively nearby industrial plant and delivered to provide such trail enhancing fluid. e.g., from a chemical plant or refinery, such as a plant making ammonia, bicarbonate, cement, ethanol, hydrogen, lime, methanol, syngas, urea, or from a power plant, such as cataloged by the DOE (2012). Slip-stream CO2 capture in larger plants may supply the trial enhancing fluid.

Larger scale CO2 generation and capture may then be provided by installing one or more calcining facilities C1, C2 and C4 to generate and capture CO2 from the local carbonate resource L1, near one or more of the first and second hydrocarbon resources H1 and H2, to and deliver it to one or more nearby hydrocarbon production sites such as the first hydrocarbon production site HP1 in the first hydrocarbon resource H1, and the second hydrocarbon production site HP2 in the second hydrocarbon resource H2, such as described herein.

Generalization

From the foregoing description, it will be appreciated that a novel approach for enhancing hydrocarbon recovery using calcined CO2 and/or solar calcined CO2 has been disclosed using one or more methods described herein. While the components, techniques and other aspects of the invention have been described with a certain degree of particularity, it is manifest that many changes may be made in the specific designs, constructions and methodology herein above described without departing from the spirit and scope of this disclosure. Other combinations of enhanced hydrocarbon or oil recovery may be utilized during one or more of primary, secondary, tertiary, and quaternary production. One or more of CO2, gas, water, viscosity thickeners, Gas Alternating Water, and CO2 Alternating Water may be used during primary, secondary, tertiary, and/or quaternary enhanced production, in new, producing, mature oil fields, brownfield residual oil zones (“brownfield ROZ”), and/or greenfield residual oil zones (“greenfield ROZ”).

Where specific parameters such as mining, crushing, calcining, hydrocarbon producing, and hydrocarbon recovery locations, fluid compositions, flow rates and operations are given, they are generally for illustrative purpose and are not prescriptive. Of course, as the mechanical, petroleum, and/or chemical process engineer will appreciate, other suitable components and configurations may be efficaciously utilized in accordance with the nature of the mining, crushing calcining, processing, and/or hydrocarbon recovery machinery utilized and for which specific flows, compositions, pressures, and locations are desired. Appropriate components and configurations may be utilized, as needed or desired, giving due consideration to the goals of achieving one or more of the benefits and advantages as taught or suggested herein.

While the components, techniques and aspects of the invention have been described with a certain degree of particularity, it is manifest that many changes may be made in the specific designs, constructions and methodology herein above described without departing from the spirit and scope of this disclosure. Various modifications and applications of the invention may occur to those who are skilled in the art, without departing from the true spirit or scope of the invention. It should be understood that the invention is not limited to the embodiments set forth herein for purposes of exemplification, but includes the full range of equivalency to which each element is entitled.

Although the present disclosure has been described in relation to particular embodiments thereof, many other variations and modifications and other uses will become apparent to those skilled in the art. It is preferred, therefore, that the present disclosure be limited not by the specific disclosure herein, but only by the appended claims.

We claim:

1. A calcining-EOR method of enhancing hydrocarbon recovery, using crushed carbonate having carbon dioxide (herein CO2) compounded with an alkaline-earth or alkali oxide, comprising:
supplying crushed carbonate from a carbonate resource to a solar first calciner at a first calcining site having a local design solar calcined CO2 generating capacity;
calcining the crushed carbonate at the first calcining site located within a prescribed solar CO2 delivery distance from a first enhancement location at a first enhancement site within a first hydrocarbon resource;
forming a first enhancing fluid from captured CO2 comprising a portion of the solar generated CO2;
injecting a portion of the first enhancing fluid into the first enhancement site, through enhancement injector wells;
whereby mobilizing hydrocarbon in the first enhancement site having an enhancement injector well weighted first enhancement location;
producing a produced fluid from the first enhancement site; and
recovering a liquid hydrocarbon from the produced fluid;
wherein the prescribed solar CO2 delivery distance is less than about 67% of a remote CO2 delivery distance to the first enhancement location from a remote calcining site having an equal or greater remote design calcined CO2 generating capacity than the local design solar calcined CO2 generating capacity.

2. The calcining-EOR method of claim 1, wherein adjusting the number of injection wells to which enhancing fluid is delivered within the first enhancement site in proportion to the rate of carbon dioxide being captured plus the rate of CO2 being recycled, while delivering CO2 at a delivery rate greater than a 0.1 hydrocarbon pore volume HCPV per year of hydrocarbon resource encompassed by a plurality of production wells surrounding the injection wells.

3. The calcining-EOR method of claim 1, wherein supplying crushed carbonate to solar second calciner at a second calcining site located within 50% of the remote CO2 delivery distance from the first hydrocarbon resource.

4. The calcining-EOR method of claim 1, further comprising solar calcining carbonate at a second calcining site near the first hydrocarbon resource, forming a second enhancing fluid comprising solar calcined CO2, delivering the second enhancing fluid into a production enhancement site in the first hydrocarbon resource analogous to the first enhancement site, and recovering mobilized hydrocarbon from the production enhancement site.

5. The calcining-EOR method of claim 1, wherein supplying crushed carbonate comprises surface mining—crushing the carbonate resource with a rotating drum surface miner, and screening the crushed carbonate such that 98% is smaller than about 102 mm (4″) in size.

6. The calcining-EOR method of claim 1, further comprising transporting a portion of the generated alkaline oxide to a demand site farther away from the first calcining site than the remote CO2 delivery distance.

7. The calcining-EOR method of claim 3, further comprising injecting enhancing fluid into a first plurality of injection wells; initially delivering blocking fluid into a second plurality of peripheral injection wells surrounding the first plurality of injection wells at the first enhancement site, followed by injecting enhancing fluid into the second plurality of peripheral wells.

8. The calcining-EOR method of claim 1, wherein beginning delivery of enhancing fluid before a primary hydrocarbon production declines to about 75% of a peak primary hydrocarbon production.

9. The calcining-EOR method of claim 1, wherein calcining carbonate using indirect heating comprising one of heat recuperation and heat regeneration.

10. The calcining-EOR method of claim 1, wherein using CO2 alternating an aqueous fluid comprising water to enhance hydrocarbon recovery.

11. A calcining hydrocarbon recovery method, comprising:
surface mining an alkaline carbonate at a carbonate site in a carbonate resource comprising carbon dioxide (herein CO2) compounded with one or more alkaline oxides of calcium and/or magnesium;
crushing mined carbonate and supplying crushed carbonate to a first calcining site;
solar calcining a portion of the crushed carbonate at the first calcining site,
whereby solar generating CO2 and an alkaline oxide;
forming a first enhancing fluid comprising a portion of the solar generated CO2;
delivering a portion of the first enhancing fluid through a plurality of injection wells into a first enhancement site comprising mobilizable hydrocarbon with a injector well weighted first enhancement location within a prescribed solar CO2 delivery distance from the first calcining site, whereby forming mobilized hydrocarbon;
producing, from the first enhancement site, a produced fluid comprising mobilized hydrocarbon and produced enhancing fluid;
separating, from the produced fluid, a recovered hydrocarbon and residual enhancing fluid; and
recycling a portion of the residual enhancing fluid to the first enhancement site;
wherein the prescribed solar CO2 delivery distance is less than about 60% of a scalar average alkali demand distance DADC, of a demand weighted average of one or more absolute scalar distances from the first mean enhancement location to one or more alkali demand locations selected from one or more population demand centers, and one or more industrial demand centers, having a combined alkali demand for alkaline oxide greater than a design rate of alkaline oxide generation in one or more calciners comprising a solar calciner installed to calcine carbonate at the first calcining site.

12. The calcining recovery method of claim 11, further comprising solar calcining carbonate at a second calcining site within the prescribed solar CO2 delivery distance of a second enhancement site in the first hydrocarbon resource, forming a second enhancing fluid, and delivering the second enhancing fluid to mobilize hydrocarbon at a second enhancement site.

13. The calcining recovery method of claim 12, wherein delivering the second enhancing fluid at the second calcining site at a second delivery rate more than three times a first delivery rate of delivering the enhancing fluid at the first calcining location.

14. The calcining recovery method of claim 12, wherein mobilizing hydrocarbon in a proving enhancement site in a second hydrocarbon resource by delivering a portion of one of the first enhancing fluid and the second enhancing fluid.

15. The calcining recovery method of claim 14, wherein delivering a third enhancing fluid comprising CO2 from outside the second hydrocarbon region to a second production enhancement site located within the second hydrocarbon resource at less than a prescribed analogous resource distance from the proving enhancement site, and mobilizing hydrocarbon in the second production enhancement site.

16. The calcining recovery method of claim 15, wherein the third enhancing fluid comprises CO2 recovered from a calcining site near a remote alkaline oxide demand center comprising one of a population region and an industrial site located farther away than the prescribed solar CO2 delivery distance from the second production enhancement site.

17. The calcining recovery method of claim 12, wherein delivering crushed carbonate to a proving carbonate calcining site located within the prescribed solar CO2 delivery distance from the proving enhancement site in the second hydrocarbon resource, solar calcining the crushed carbonate and delivering a portion of enhancing fluid comprising solar CO2 formed thereby to mobilize hydrocarbon in the proving enhancement site.

18. The calcining recovery method of claim 13, wherein screening the crushed carbonate and supplying screened limestone with the prescribed screen size of about 76 mm (3″) in size for calcining.

19. The calcining recovery method of claim 13, further delivering enhancing fluid and mobilizing hydrocarbon at a plurality of enhancement sites,
wherein a production well weighted production distance, to a mean enhancement center of the plurality of enhancement sites, from a mean solar calcining center of a plurality of calcining sites comprising a solar calciner near the first hydrocarbon resource, is less than about 50% of the average alkali demand distance, of the demand weighted scalar distances to the mean enhancement center from a plurality of said alkali demand locations having collectively an equal or greater alkaline demand than the design calcining capacity of plurality of calcining sites.

20. The calcining recovery method of claim 11, wherein delivering enhancing fluid into the plurality of injection wells at the rate of recovering enhancing fluid plus generating enhancing fluid using at least 85% of an enhancing fluid generating design capacity of the one or more calciners, and configuring the number of injection wells to maintain the enhancing fluid delivery pressure between 75% and 100% of a prescribed safe delivery pressure.

21. The calcining recovering method of claim 11, wherein beginning delivery of enhancing fluid before a beginning of hydrocarbon production or before a primary hydrocarbon production rate reaches an inflection point where an accelerating rise in the primary hydrocarbon production rate changes to a decelerating rise.

22. The calcining recovery method of claim 11, wherein proving a reserve of CO2 enhanced hydrocarbon production within the first hydrocarbon resource within 24 months of first delivering enhancing fluid.

23. The calcining recovery method of claim 11, wherein delivering enhancing fluid into the first enhancement site at a rate of more than 0.2 HCPV/year of the hydrocarbon resource served by the plurality of injection wells delivering the enhancing fluid.

24. A method of calcining-proving hydrocarbon recovery, comprising:
mining at a first mining site a carbonate resource comprising a carbonate of calcium and/or magnesium, within a prescribed mining distance from a first hydrocarbon enhancement site in a first hydrocarbon resource;
crushing the carbonate and delivering a portion of the crushed carbonate to a solar first calciner at a first calcining site having a local calcining design capacity;
calcining the portion of the delivered crushed carbonate,
whereby solar generating carbon dioxide (herein CO2) and alkaline oxide;
delivering an enhancing fluid comprising a portion of the solar generated CO2 into a first enhancement site, whereby mobilizing a hydrocarbon;
producing, from the first enhancement site, a produced fluid comprising mobilized hydrocarbon and enhancing fluid; and
separating, from the produced fluid, a recovered hydrocarbon and a recovered fluid comprising CO2;
wherein recovering hydrocarbon with a hydrocarbon production profile for a duration sufficient to prove a first reserve of CO2 co-producible hydrocarbon; and
wherein the prescribed mining distance is less than about 50% of a remote calcining distance, to the first enhancement site from a remote calciner site having a remote design calcining capacity equal to or greater than the local calcining design capacity.

25. The calcining-proving method of claim 24, wherein delivering sufficient enhancing fluid for a duration sufficient to demonstrate a CO2-enhanced hydrocarbon recovery rate greater than a base primary hydrocarbon production recovery rate without the enhancing fluid, and projecting a CO2 enhanceable hydrocarbon reserve above a base projected hydrocarbon reserve.

26. The calcining-proving method of claim 25, wherein identifying a first inflection point showing a declining rate of increase in the hydrocarbon production rate; and wherein delivering sufficient enhancing fluid for a duration long enough to cause a second inflection point with an accelerating rate of increase in the hydrocarbon production rate, whereby showing a production enhancement by an increasing rate of increase in the hydrocarbon production rate.

27. The calcining-proving method of claim 25, further comprising showing that a second hydrocarbon resource having a mining distance from the first mining site less than about 50% of the remote calcining distance is analogous to the first hydrocarbon resource, and projecting the demonstrated CO2 enhanced hydrocarbon recovery at the first hydrocarbon site onto the second analogous resource, to project a second reserve of CO2 enhanceable hydrocarbon in the second analogous resource.

28. The calcining-proving method of claim 24, wherein a first local trial solar CO2 delivery distance, to the center of a first trial enhancement site HT1 from the local solar first calciner at the solar first calcining site, is less than about 67% of a first remote CO2 delivery distance, to the first enhancement or hydrocarbon trial site HT1 from a first remote calciner at a remote calcining site, having an equal or greater remote CO2 generating capacity than the local CO2 generating capacity of the local solar first calciner.

29. The calcining-proving method of claim 24, wherein a first local production solar CO2 delivery distance, to a center of the first production enhancement site HP1 from the solar second calciner at a second calcining site, may be less than about 50% of a second remote CO2 delivery distance, to the center of first enhancement site HP1 from the location of a second remote calciner at a remote calcining site, wherein the second remote calciner has an equal or greater remote CO2 generating capacity than the local CO2 generating capacity of the local solar second calciner.

30. The calcining-proving method of claim 24, wherein a local mean solar CO2 delivery distance, to a first hydrocarbon center HC1 of the first hydrocarbon resource H1, weighted by an oil in place, from the mean of locations of the solar first calciner location and the solar second calciner, is less than about 40% of a remote mean CO2 delivery distance to the first hydrocarbon center HC1 of hydrocarbon resource H1 from the mean of the location of the nearest first remote calciner and the location of the next nearest second remote calciner, together having an equal or greater CO2 generating capacity than the combined capacity of the solar first calciner and the solar second calciner.

31. The calcining-proving method of claim 24, wherein a first local solar CO2 production delivery distance to the first hydrocarbon center HC1 of first hydrocarbon resource H1 from the solar second calciner is less than about 65% of a remote alkali demand distance for alkaline oxide DADC, from the first hydrocarbon center HC1 to an alkali demand center ADP of a first remote population region P1 such as is supplied by the first remote calciner and a second remote population region P2, such as is supplied by the second remote calciner.

32. The calcining-proving method of claim 24, wherein a mean solar CO2 delivery distance to the first resource weighted hydrocarbon center HC1 of first hydrocarbon resource H1 from a production weighted solar calcining center SCCT of a plurality of nearby operating calciners comprising a solar calciner having a combined design alkaline oxide generating capacity, is less than about 50% of a remote mean demand distance CM of an alkali demand weighted average of scalar distances from the first hydrocarbon center HC1 to an a plurality of one or more of the first population center PC1, the second population center PC2, the first industrial user IU1 and the second industrial user IU2, having an alkali demand for alkaline oxide greater than the local combined design alkaline oxide production capacity of the plurality of nearby operating calciners.

33. The calcining-proving method of claim 24, wherein a mean alkali demand distance, of the average scalar distances from an area weighted mean enhancement location HE1, of the first hydrocarbon trial site HT1 and the first production enhancement site HP1, to one or more remote alkali demands for alkaline oxide, comprising one or more of population centers and one or more industrial users, is greater than a production distance, to the first mean enhancement location HE1 from the first mean supply location CS1 of the mining site comprising quarry Q1 and quarry Q2, wherein the remote alkali demand is greater than the combined local calcining design capacity.

34. The calcining-proving method of claim 24, further comprising providing a buffer store of surface mined carbonate sufficient to generate CO2 to deliver to the first enhancement site enhancing fluid comprising CO2 at 85% of the local calcining design capacity for at least six months.

35. The calcining-proving method of claim 24, wherein proving enhanced liquid hydrocarbon production from the first hydrocarbon resource within 12 months of first delivering enhancing fluid.

36. The calcining-proving method of claim 24, wherein proving the enhanceable hydrocarbon resource at a second nearby or analogous enhancement site with CO2 from one of an existing CO2 source and a relocatable CO2 source, and then calcining to generate CO2 from crushed carbonate at the second nearby enhancement site.
